(19) United States
(12) Patent Application Publication
(10) Pub. No.: US 2008/0158563 A1
(43) Pub. Date: Jul. 3, 2008

(54) Sensors

(76) Inventors: Pierre Simon Joseph Berini, Orleans (CA); Robert Charbonneau, Kanata (CA); Nancy Lahoud, Kanata (CA)

Correspondence Address: ADAMS PATENT & TRADEMARK AGENCY, P.O. BOX 11100, STATION H, OTTAWA, ON, K2H 7T8, omitted

(21) Appl. No.: 11/892,062

(22) Filed: Aug. 20, 2007

Related U.S. Application Data
(60) Provisional application No. 60/838,861, filed on Aug. 21, 2006.

(51) Int. Cl. G01N 21/00

(52) U.S. Cl. 356/437

(57) ABSTRACT

A gas sensor for hydrogen or other gases, especially flammable or explosive gases, has a plasmon-polariton waveguide comprising a metal strip on a membrane supported by a substrate in an environment in which the gas is to be introduced, and coupling means for coupling optical radiation into and out of the plasmon-polariton waveguide such that the optical radiation propagates therealong as a plasmon-polariton wave. The metal strip comprises by a chemical transducer (e.g. Pd or PdNi), the arrangement being such that exposure of the metal strip or coating to the gas to be monitored causes a change in the propagation characteristics of the plasmon-polariton wave and hence the optical radiation coupled out of the plasmon-polariton waveguide.

### CROSS-REFERENCE TO RELATED APPLICATION

This application claims priority from U.S. Provisional patent application No. 60/838,861 filed Aug. 21, 2006, the contents of which are incorporated by reference.

### TECHNICAL FIELD

The invention relates to sensors, particularly sensors for sensing gases, and is especially applicable to sensors for sensing flammable or explosive gases, such as hydrogen.

### BACKGROUND

In the context of this patent specification:

The term “optical radiation” embraces electromagnetic waves having wavelengths in the infrared, visible and ultraviolet ranges.

The terms “finite” and “infinite” as used herein are used by persons skilled in this art to distinguish between waveguides having “finite” widths in which the actual width is significant to the performance of the waveguide and the physics governing its operation and so-called “infinite” waveguides where the width is so great that it has no significant effect upon the performance and physics of operation. Following this convention, dimensions in general that are said to be “optically infinite” or “optically semi-infinite” are so large that they are insignificant to the optical performance of the device.

The refractive index of a material is denoted n and is related to its relative permittivity ∈ᵣ according to ∈ᵣ=n². The relative permittivity ∈ᵣ is related to the absolute permittivity ∈ via ∈=∈ᵣ∈₀ where ∈₀ is the absolute permittivity of free space or vacuum.

A material said to have a “high free (or almost free) charge carrier density” is a material of a primarily metallic character exhibiting properties such as a high conductivity and a high optical reflectivity. Examples of such materials are (without limitation) metals, semi-metals and highly doped semiconductors.

A material said to have a “low free (or almost free) charge carrier density” is a material of a primarily dielectric character exhibiting properties such as a low conductivity. Examples of such materials are (without limitation) insulators, dielectrics, and undoped or lightly doped semiconductors

An environment said to have a “low free (or almost free) charge carrier density” includes a gas, gaseous mixture (for instance air) having a primarily dielectric character exhibiting properties such as a low conductivity, and a vacuum.

Recognizing that, in practice, an absolute vacuum cannot be achieved, the term “lvacuum” is used herein for an environment in which the effects of any residual material are negligible.

For convenience of description, the word “gas” as used herein should be construed as including a mixture of gases, as appropriate in the context.

The term “analyte” as used herein describes something that is to be detected or sensed within a prescribed environment, and can be, for example, a gas molecule which may be a constituent of the environment.

The term “adlayer” as used herein embraces at least one layer that is adhered or otherwise provided upon a surface. It also embraces surface chemistries.

Hydrogen gas may be used in many different applications, including as a rocket propellant, in industrial processes, such as in the chemical, electronics and metallurgical fields, in fuel cells for vehicles, electronic devices such as mobile telephones, portable computers, and power backup systems. The production, storage and transportation of hydrogen gas present certain problems because it is explosive. For safety reasons, therefore, it is desirable to be able to monitor hydrogen concentrations in various hazardous settings.

In general, it is desirable for sensors suitable for monitoring hydrogen to be chemically selective, sensitive, reversible, fast, durable, temperature insensitive, have a low power consumption and have a low detection limit. In addition, it may be desirable for them to be easy to use, small, portable, inexpensive and capable of remote use.

Known sensors suffer from a number of limitations such as large size, low sensitivity, small dynamic range, large power consumption. Furthermore, electrical sensors of hydrogen gas can be hazardous in an explosive environment due to the possibility of sparking.

An object of the present invention is to overcome or at least mitigate limitations of such known sensors, or at least provide an alternative sensor for sensing gases or gaseous mixtures.

### SUMMARY OF THE INVENTION

According to the present invention, there is provided gas sensor means having a plasmon-polariton waveguide comprising a metal strip on a membrane supported by a substrate in an environment in which the gas to be sensed is to be introduced, the metal strip comprising a chemical transducer (e.g., Pd, PdNi or another metal or metal alloy), and coupling means for coupling optical radiation into and out of the plasmon-polariton waveguide such that the optical radiation propagates therealong as a plasmon-polariton wave, the arrangement being such that exposure of the metal strip to the gas to be sensed causes a change in the propagation characteristics of the plasmon-polariton wave propagating along the waveguide and hence the optical radiation coupled out of the plasmon-polariton waveguide.

The strip may be formed of the chemical transducer metal. Alternatively, the strip may be formed of another suitably-conductive metal and the chemical transducer metal as laminae. In particular, the strip may comprise a suitably-conductive metal having the chemical transducer metal formed upon its surface by deposition or other suitable means.

The chemical transducer material may be selected according to the gas to be sensed. For example, where the gas is hydrogen, the chemical transducer material may be palladium or a palladium-based alloy, such as palladium-nickel.

The coupling means may comprise a waveguide, for example a dielectric waveguide, for coupling input optical radiation to one end of said strip so as to propagate along said strip as said plasmon-polariton wave.

Alternatively, the coupling means may comprise, for example, a prism coupler or a grating patterned within a portion of the strip for coupling input optical radiation laterally to said strip to propagate as said plasmon-polariton wave.

Whether the input optical radiation is coupled via said one end or laterally, the coupling means may further comprise a waveguide, for example a dielectric waveguide, for extracting at least part of said plasmon-polariton wave at an opposite end of said strip, or means, for example a prism coupler or a grating patterned within a portion of the strip, for extracting at least part of said plasmon-polariton wave laterally from said strip.

The strip may have a width much greater than its thickness, in which case the plasmon-polariton waveguide will be substantially polarization sensitive and the input optical radiation, preferably, linearly polarized. The coupling means then may comprise a polarization maintaining fiber for inputting said optical radiation and either another polarization maintaining fiber or a conventional single mode fiber for conveying optical radiation output from the waveguide.

The coupling means may convey optical radiation from the waveguide to optoelectronics means for converting the optical radiation from the plasmon-polariton waveguide to an electrical signal representative of the gas, if any, contacting the metal strip. The optoelectronic means may be located nearby, for example within the same compact module, or at a remote location, such as in another building.

The membrane means may extend between spaced supports.

The membrane means may be permeable, apertured, porous or otherwise configured so as to allow the gas to contact the chemical transducer through the membrane means. Such a membrane means will allow chemical transducer on both major surfaces of the strip to be exposed to the gas, at least over a desired part of the strip.

Preferably, the optical device further comprises means for confining a said environment (E) and means for admitting the gas to be sensed into the confined environment, and the membrane supports said strip such that at least said chemical transducer extends at least partially within said confined environment.

Various objects, features, aspects and advantages of the present invention will become more apparent from the following detailed description, taken in conjunction with the accompanying drawings, of preferred embodiments of the invention, which is provided by way of example only.

### BRIEF DESCRIPTION OF THE DRAWINGS

FIG. 1 is a plan view of a surface plasmon-polariton waveguide structure portion of an optical device embodying the present invention, showing optical input and output waveguide sections butt-coupled to the waveguide structure;

FIG. 2 is a side view of the surface plasmon-polariton waveguide structure portion of FIG. 1;

FIG. 3 is a partial cross-sectional perspective view of the surface plasmon-polariton waveguide structure taken on the line II-II of FIG. 1, without the optical input and output waveguide sections;

FIG. 4 is a cross-sectional end view of the surface plasmon-polariton waveguide structure also taken on the line II-II of FIG. 1 showing the optical output waveguide section;

FIG. 5 is a cross-sectional end view of a second embodiment wherein the waveguide structure extends within a tube;

FIG. 6 is a plot of the effective refractive index β/β₀ of the ss_{b}⁰ mode supported by the optical waveguide of FIG. 1 or 5 having a first set of parameters; the plot also shows the effective refractive index of the TE₀ and TM₀ modes supported by the membrane alone;

FIG. 7 is a plot of the attenuation of the ss_{b}⁰ mode supported by the waveguide structure having the first set of parameters;

FIGS. 8(a) and 8(b) are plots of the spatial distribution of Re{E_{y}} over the cross section for each of two specific geometries of the waveguide with the first set of parameters, plot 8(a) for d=1 nm, and plot 8(b) for d=20 nm;

FIG. 9 is a plot of the effective refractive index β/β₀ of the ss_{b}⁰ mode supported by a waveguide of FIG. 1 or 5 with a second set of parameters; the plot also shows the effective refractive index of the TE₀ and TM₀ modes supported by the membrane alone;

FIG. 10 is a plot of the attenuation of the ss_{b}⁰ mode supported by the waveguide with the second set of parameters;

FIGS. 11(a) and 11(b) are plots of the spatial distribution of Re{E_{y}} over the cross section for each of two specific geometries of the waveguide having the second set of parameters; FIG. 11(a) for d=1 nm, FIG. 11(b) for d=20 nm;

FIG. 12 is a plan view of a modification to either of the first and second embodiments;

FIG. 13 is a partial cross-sectional view taken on the line X-X of FIG. 22;

FIGS. 14(a), 14(b), 14(c) and 14(d) give the computed distribution of Re{E_{y}} over the waveguide cross-section for several sets of waveguide dimensions and operating parameters;

FIGS. 15(a) and 15(b) are an isometric view and a longitudinal cross-sectional view, respectively, of an alternative membrane waveguide structure;

FIGS. 16(a) and 16(b) are an isometric view and a top plan view, respectively, of another waveguide structure similar to that shown in FIGS. 15(a) and 31(b);

FIG. 17 shows a waveguide structure wherein the membrane width m is less than the trench diameter v;

FIGS. 18(a) and 18(b) are front and partial longitudinal cross-section views, respectively, of a modified waveguide structure having two prism couplers interfacing input and output fibers, respectively, with its top surface;

FIGS. 19(a) and 19(b) illustrate addition of optional spacing rails to the waveguide structure of FIGS. 18(a) and 18(b);

FIG. 20 is a partial side view of the waveguide structure of FIGS. 18(a) and 18(b);

FIG. 21 illustrates fiber to fiber insertion loss for various lengths of waveguide having a clamped membrane as shown in FIGS. 15(a) and 15(b), a microscope image of a typical fabricated structure being shown inset;

FIG. 22 illustrates a waveguide structure having scattering means defined lithographically on a top surface of the strip;

FIG. 23(a) is a schematic transverse cross-sectional view of a waveguide structure having an adlayer located along the top surface of the strip;

FIG. 23(b) is a schematic transverse cross-sectional view of a waveguide structure without an adlayer located along the top surface of the strip;

FIG. 24 is a plot of the spatial distribution of Re{E_{y}} over the cross section for a specific geometry of the waveguide;

FIG. 25 gives the computed sensitivity ∂n_{eff}/∂h(c) in dB/10 μm of the ss_{b}⁰ mode over ranges of strip and membrane thickness t and d for the waveguide structure of FIG. 38(b);

FIG. 26 gives the computed sensitivity ∂n_{eff}/∂h(c) of the ss_{b}⁰ mode over ranges of strip and membrane thickness t and d for waveguide structure of FIG. 38(b);

FIG. 27(a) shows schematically an attenuation-based straight waveguide sensor embodying the invention;

FIG. 27(b) shows schematically an attenuation-based straight waveguide sensor embodying the invention with an input coupler and a reference output;

FIG. 27(c) shows schematically an attenuation-based straight waveguide sensor embodying the invention with an input Y-junction splitter and a reference output;

FIG. 28(a) shows schematically a Mach-Zehnder interferometric sensor embodying the invention and having a Y-junction combiner at its output;

FIG. 28(b) shows schematically a Mach-Zehnder interferometric sensor similar to that of FIG. 28(a) but with the Y-junction combiner replaced with a dual-output coupler;

FIG. 28(c) shows schematically a Mach-Zehnder interferometric sensor similar to that shown in FIG. 28(b) but with a triple-output coupler;

FIGS. 29(a) to (e) illustrate implementation of the Mach-Zehnder interferometer sensor;

FIGS. 30(a) to (e) correspond to FIGS. 29(a) to (e) but of an arrangement in which the output prism-like coupler is replaced with a scattering centre;

FIGS. 31(a) to (e) are, respectively, cross-sectional, plan, end and side views of a physical implementation of the interferometer of FIG. 28(a);

FIGS. 32(a) and 32(b) are a schematic transverse cross-section view and a side view, respectively, of a waveguide structure resulting from the combination of the bottom chip shown in FIGS. 31(a)-(c) and the top chip shown in FIGS. 31(d)-(e).

### DETAILED DESCRIPTION OF PREFERRED EMBODIMENTS

### Waveguide Structure:

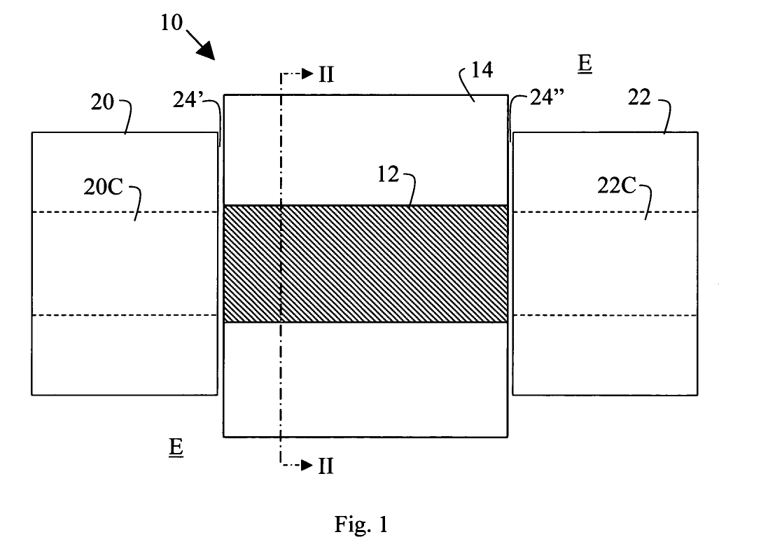

Referring to FIGS. 1, 2, 3 and 4, an optical device 10 comprises a surface plasmon-polariton waveguide structure comprising a strip 12 of material of high free (or almost free) charge carrier density and having thickness t, width w and permittivity ∈₃, supported by a membrane 14 of material of low free (or almost free) charge carrier density of thickness d and permittivity ∈₂, in an environment E of low free (or almost free) charge carrier density of permittivity ∈₁. The strip 12 is attached, specifically adhered, to the membrane 14, preferably during fabrication.

The membrane 14 of width m extends across the mouth of a channel or cavity 16, shown here rectangular in section, provided in a substrate 18, leaving longitudinal supports 18A and 18B on either side of the channel 16. Opposite margin portions 14A and 14B of the membrane 14 overlie and are attached to distal end surfaces 18A′ and 18B′, respectively, of the supports 18A and 18B, conveniently by bonding during fabrication.

The ends of the channel 16 are open so that, in the region of the waveguide structure, the environment E is partitioned by the membrane 14 into optically semi-infinite portions, each portion extending away from the membrane 14 in the direction perpendicular to the width w of the strip 12.

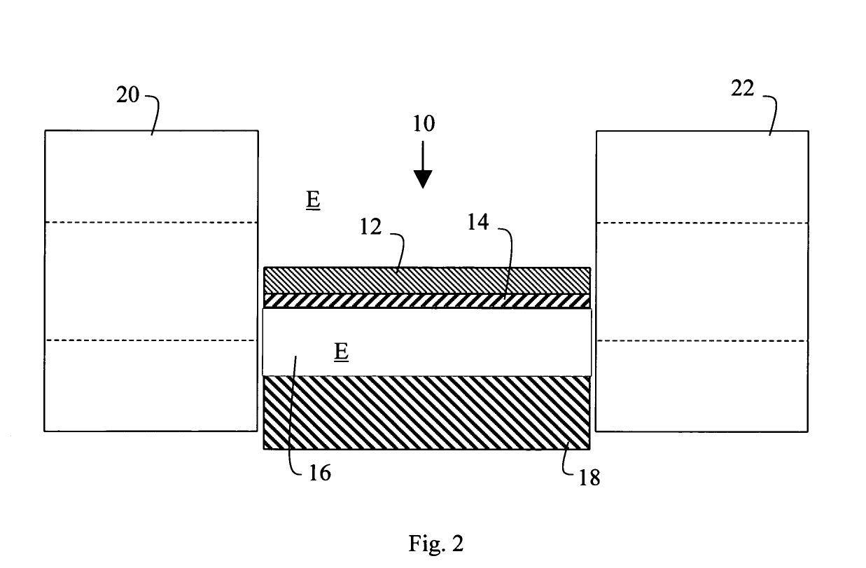

As shown in FIGS. 1 and 2, an optical input waveguide 20 and an optical output waveguide 22, conveniently dielectric waveguides in integrated optics circuits, or optical fibers, are butt-coupled to respective ends of the waveguide structure. Small gaps 24′ and 24″ between the ends of the waveguides 20 and 22, respectively, and the “abutting” ends of the waveguide structure (strip 12, membrane 14 and environment E) facilitate optical coupling and reduce the risk of damage to the strip 12 and membrane 14. Alternatively, coupling can be achieved via the top surface using prism couplers, as will be described in more detail later with reference to FIGS. 33 to 37.

The interior of the channel 16 is in communication with the portion of the environment E at the opposite surface of the membrane 14, i.e., which carries the strip 12. Thus, the environment E is substantially the same each side of the strip 12 and membrane 14. It should be noted that the membrane 14 is not considered to be part of the environment.

A second channel (not shown) could be provided, conveniently perpendicular to the channel 16, either meeting the first channel 16 to form a T-shaped channel arrangement or extending across the first channel 16 to form a cruciform channel arrangement open at one or two ends. Such a T-shaped or cruciform channel arrangement would facilitate circulation between the environment portions at opposite sides of the strip 12.

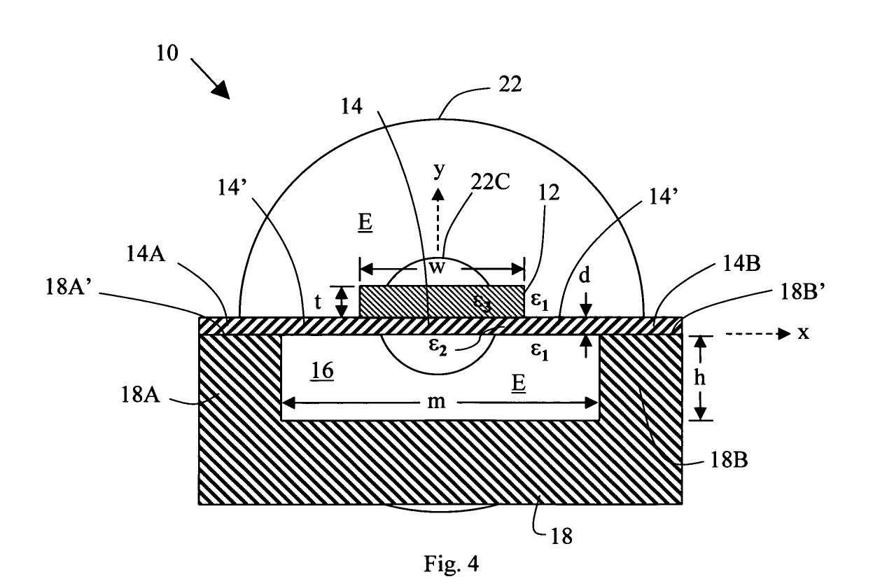

FIG. 5 is a cross-sectional view of a second embodiment that is similar to that shown in FIGS. 1, 2, 3 and 4 but differs in that the membrane 14 extends across the middle of a tube formed from cavities 16′ and 16″ shown as having a rectangular cross-section, conveniently formed by two U-shaped channel members 18′, 18″ similar to substrate 18 of the first embodiment joined along juxtaposed longitudinal edges 18A′, 18A″ and 18B′, 18B″ of their respective support ridges. As before, the strip 12 is attached, specifically adhered, to the membrane 14, preferably during fabrication, so that it extends longitudinally along the tubular axis. Such an arrangement facilitates manipulation of the environment portions on opposite sides of the strip 12.

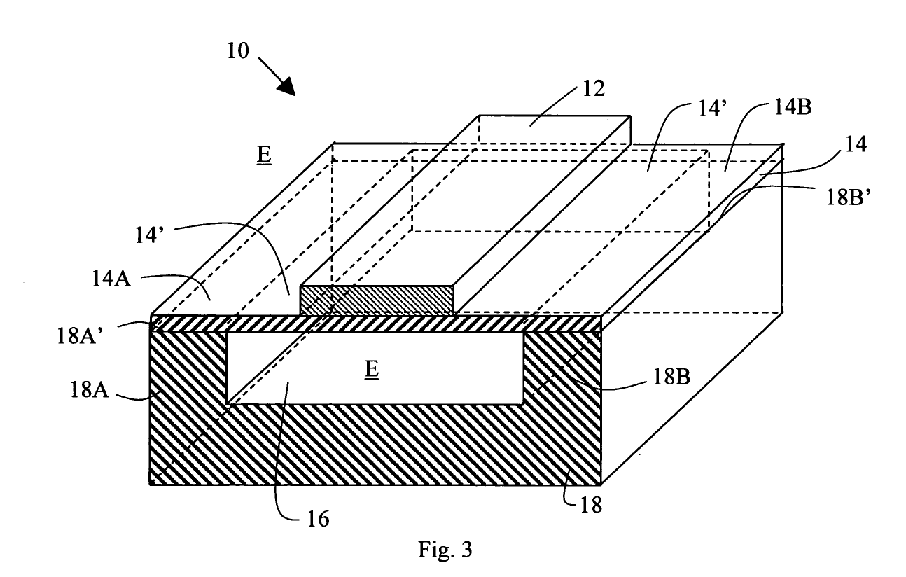

Although the strip 12 is shown in FIGS. 3 and 4 on the surface of membrane structure 14 remote from the substrate 18, it could be on the surface of the membrane structure facing the substrate 18.

A thin, protective covering could be provided over that surface of the strip 12 shown uppermost in FIG. 2, for example to isolate it from the fluid in the environment. Alternatively, the strip 12 could be encapsulated within the membrane 14 itself.

Although the channel 16 and tube formed from the cavities 16′ and 16″ are each shown with a rectangular cross-section, other cross-sectional shapes may be used.

As shown in FIG. 1 the cores 20C and 22C of the waveguides 20 and 22, respectively, are shown as having diameters approximately equal to the width of the strip 12. However, the strip width w could be made larger or smaller than the core diameter according to whether or not coupling loss was to be minimized, which would entail mode-matching between the waveguide(s) and the strip 12.

In both of the above-described embodiments, the membrane 14 is suspended between supports 18A, 18B. It is envisaged, however, that other forms of support could be used; for example a membrane and four pillars at its respective corners, or a membrane with four ligatures suspending its four corners, or held by one or more cantilevers, or a membrane with ligatures spaced apart along its length and coupled to a longitudinal support, and so on, providing the membrane means and, where applicable, its support(s), remain substantially non-invasive optically in the vicinity of the strip 12. It is also desirable for the membrane 14 to be subjected to a tensile or slightly tensile stress to ensure that it will be taut.

In either of the above-described embodiments, although the strip 12 is shown in the middle of the membrane 14, it could be offset to either side.

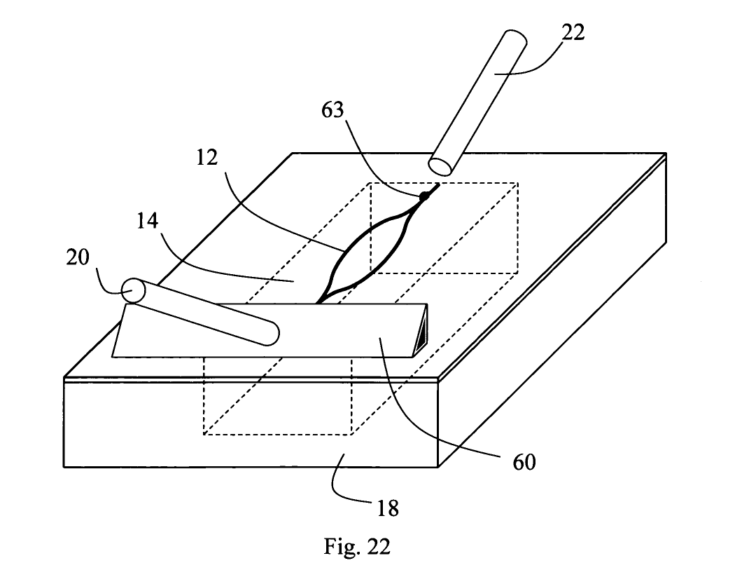

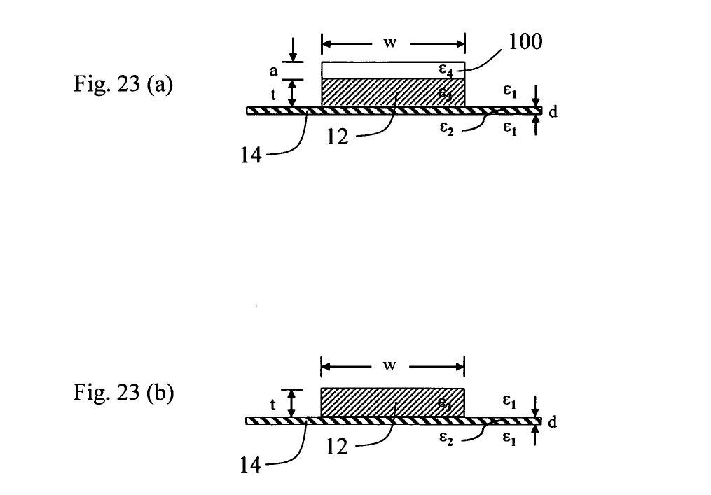

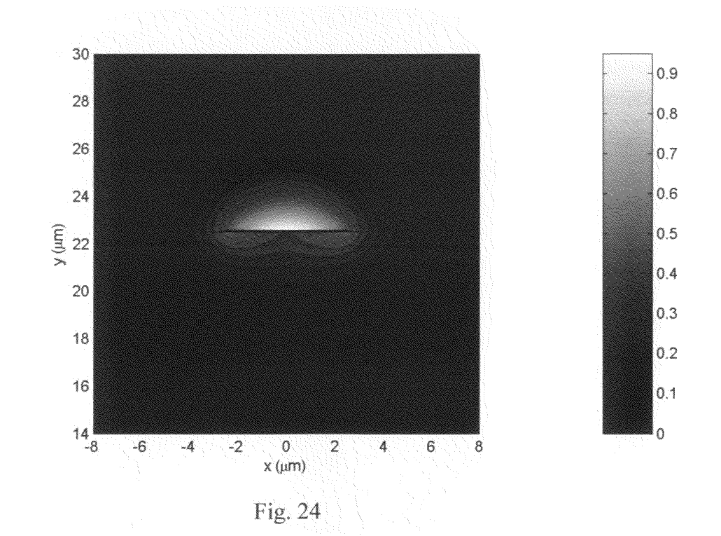

FIGS. 22 and 23 illustrate a modification applicable to either of the above-described embodiments. The modification entails providing a series of apertures 26, conveniently but not necessarily rectangular, as shown, along the length of the membrane 14 so that both major surfaces of the strip 12 are exposed to (contact) the environment E. As shown, the whole of the uppermost major surface is exposed, but only part of the lowermost major surface is. That is because the width of each of the apertures 26 is less than the width of the strip 12 so that, as shown in FIG. 23, a medial portion 28 of the strip 12 protrudes into each aperture 26 (so their respective lowermost surfaces are flush) leaving opposite lateral edge portions 30 of the strip 12 overlying the regions 32 of the membrane 14 around the apertures 26. The strip 12 will, of course, also overlie the membrane divider portions 34 separating the apertures 26, as shown in FIG. 22. Two rows of through holes 36 along opposite sides of the membrane 14 allow communication between the environment portions on opposite sides of the membrane 14 and strip 12.

In waveguide structures embodying the present invention, the materials, and dimensions are selected such that optical radiation can be coupled to the strip 12 and will propagate along the strip 12 as a surface plasmon-polariton wave. Examples of suitable materials are set out below.

Suitable materials for the membrane 14 include good optical dielectrics such as (but not limiting to) glass, quartz, polymer, SiO₂, Si₃N₄, silicon oxynitride (SiON), LiNbO₃, PLZT, and undoped or very lightly doped semiconductors such as GaAs, InP, Si and Ge. Preferred materials for the membrane 14 are SiO₂, SiON and Si₃N₄ due to their strength and chemical stability, with Si₃N₄ and nitride rich SiON being particularly preferred due to the tensile nature of the stress that develops within the material when deposited using standard deposition techniques. Since the margin portions 14A and 14B of the membrane 14 will be held by the mechanical supports 18A and 18B, a tensile or slightly tensile stress ensures that it will be taut. Polymers that would be suitable for the membrane include, for example, BCB, polyimide, PMMA, Teflon AF (TM), SU8, Cytop, PTFE, PFA and so on.

Suitable materials for the strip 12 include good conductors such as (but not limiting to) metals, semi-metals, highly n- or p-doped semiconductors or any other material that behaves like a metal. Suitable metals for the strip 12 may comprise a single metal or a combination of metals (alloys or laminates), conveniently selected from the group Au, Ag, Cu, Al, Pt, Pd, Ti, Ni, Mo and Cr. Metal silicides such as CoSi₂ are particularly suitable when the membrane material is Si. Suitable semiconductors for the strip 12 include highly n- or p-doped GaAs, InP, Si and Ge. Materials that behave like metals at the operating wavelength may also be used, such as Indium Tin Oxide (ITO). Preferred materials for the strip 12 are Au, Ag, Cu and Al, with Au being particularly preferred due to its chemical stability. For the purposes of sensing hydrogen, preferred metals for the strip 12 or portions thereof include Pd and Pd-rich alloys such as Pd_{0.92}Ni_{0.08}.

Suitable materials for the substrate 18 include the materials identified above for the membrane 14, with the preferred material being Si.

The environment may comprise matter in the gaseous state, for example (but not limiting to), air or other gaseous mixtures.

### Design Considerations:

Embodiments of the invention comprise a composite waveguide structure: the membrane 14, when taken alone, supports a spectrum of bound dielectric optical slab modes and the strip 12, when taken alone, supports a spectrum of bound surface plasmon-polariton modes. The modes of interest are those of the composite structure, and the mode of particular interest is the ss_{b}⁰ mode.

Confinement of the ss_{b}⁰ mode in the direction perpendicular to the plane of the width of the strip 12 (referred to as “vertical” for convenience) is achieved by ensuring that the effective refractive index (n_{eff}=β/β₀, where β₀=2π/λ₀ is the phase constant of free space and λ₀ is the free-space wavelength) of the ss_{b}⁰ mode is greater than the refractive index of the environment E. At the same time, confinement of the ss_{b}⁰ mode in the direction parallel to the width of the strip 12, (“horizontal” for convenience) is achieved by ensuring that its effective refractive index is greater than that of the TE₀ and TM₀ modes supported by the membrane-only regions 14′ on either side of the strip 12 (shown in FIGS. 3, 4 and 5). Strictly speaking, if this latter condition is not met, then radiation leakage can occur via coupling into the TE₀ and TM₀ modes guided by membrane 14 in directions away from the strip 12. In practice, however, coupling into the TE₀ mode, which is horizontally polarized, is in general insignificant since the ss_{b}⁰ mode is substantially TM (substantially vertically polarized) and so is orthogonal to the TE₀ mode.

Designing a waveguide structure embodying this invention entails selecting materials and dimensions such that the ss_{b}⁰ mode is confined as described above, has a desired propagation constant (effective refractive index β/β₀ and attenuation α; the mode power attenuation—MPA—in dB/m is given by α20 log₁₀(e)) and an appropriate mode field distribution. What constitutes “desired” and “appropriate” will depend upon the application. For example, to minimize insertion loss, it would be “desirable” to have low waveguide attenuation and low coupling losses to the input and output means. In the case where the input and output means correspond to other waveguides butt-coupled to the structure, an “appropriate” field distribution is that distribution that at least approximately matches the distribution of the mode field of the waveguide used as the butt-coupled input and output waveguides. Furthermore, the mode field used as the excitation preferably is polarization-aligned with the ss_{b}⁰ mode, which is substantially TM (substantially vertically polarized).

As mentioned above, the membrane 14 should not be too invasive optically, placing an upper bound on its optical thickness. It should also be mechanically sound so as to provide the required support, placing a lower bound on its physical thickness. Furthermore, it should be sufficiently wide that the supports 18A and 18B are far enough from the strip 12 to be non-invasive optically, placing a lower bound on its width m.

Using computer modeling techniques as disclosed in U.S. Pat. No. 6,442,321 (supra), the waveguide structure was analyzed in depth for different combinations of materials and dimensions for the strip 12 and membrane 14, in a vacuum environment E, at several typical operating wavelengths. Operation in a gaseous environment such as air is comparable optically to operation in vacuum. The analysis involved generating numerically the ss_{b}⁰ mode supported by a particular waveguide case, in the manner described in U.S. Pat. No. 6,442,321.

For purposes of illustration, and without limiting the scope of the present invention, several examples of a variety of combinations of materials and dimensions for the waveguide structure of the sensor will now be described, together with the analysis of the resulting waveguide structure.

### Example 1

The free-space operating wavelength was set to 1550 nm, SiO₂ (∈_{r,2}=1.444²) was selected as the material of the membrane 14, Au (∈_{r,3}=−131.95−j12.65) was selected as the material of the strip 12, and vacuum (∈_{r,1}=1) was selected as the environment E. The width w of the strip 12 was set to 8 μm, its thickness t was set to 30 nm, and the thickness d of the membrane 14 was varied from substantially 0 to about 65 nm for the purpose of illustrating its impact on the performance of the waveguide.

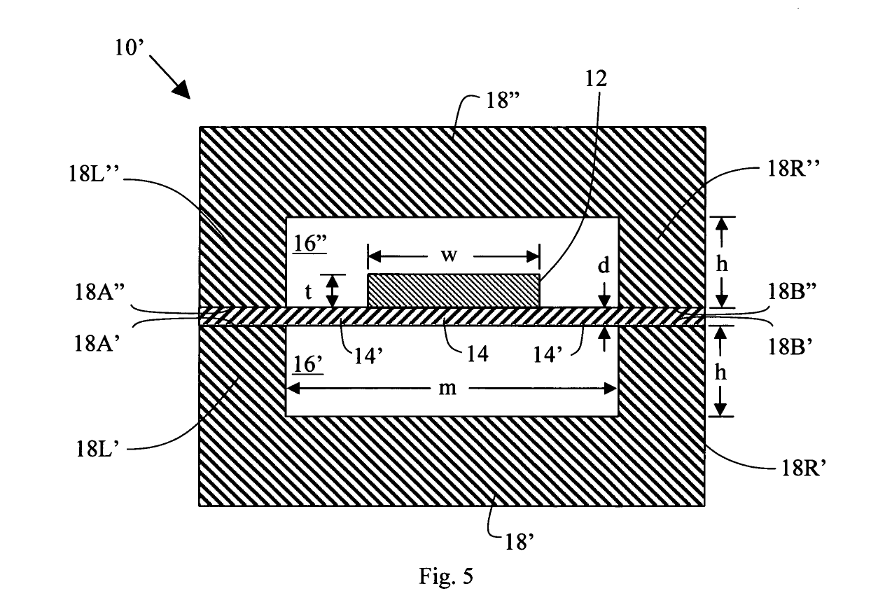

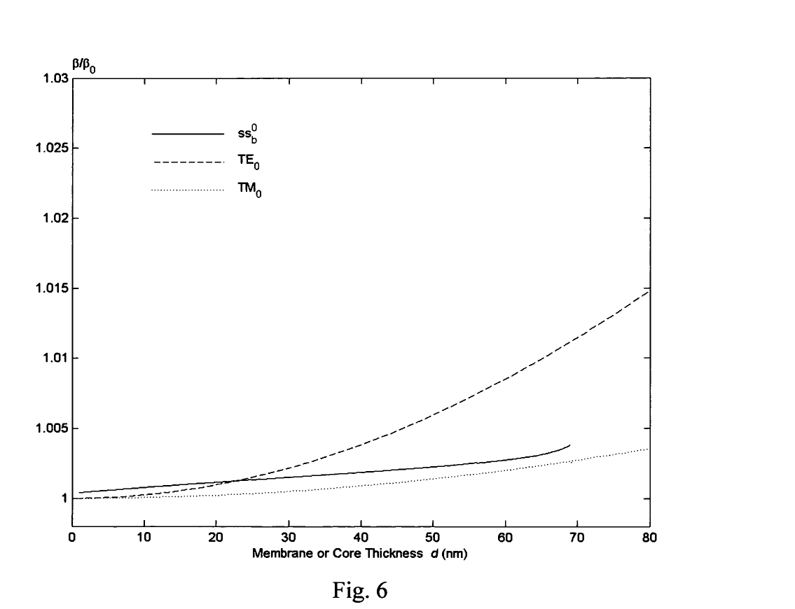

FIG. 6 gives the computed effective refractive index β/β₀ of the ss_{b}⁰ mode over the range of membrane thicknesses d. The effective refractive index of the TE₀ and TM₀ modes supported by the membrane 14 alone (i.e.: without the strip 12) was also plotted for reference.

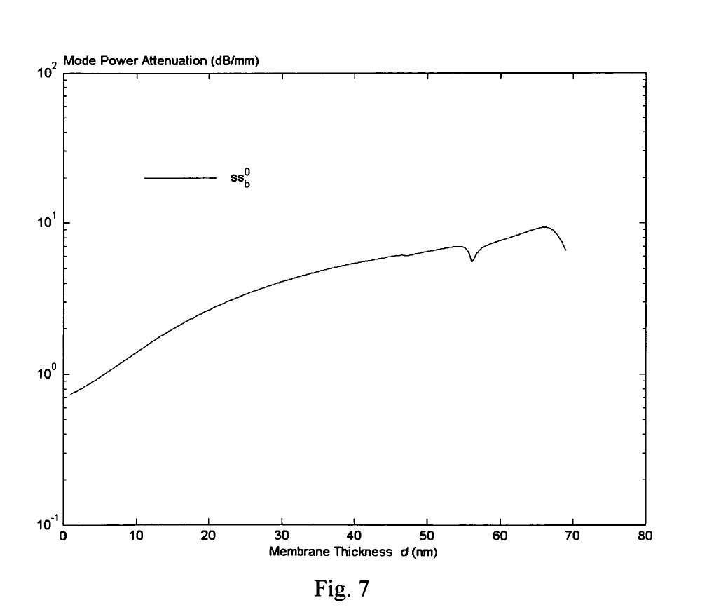

FIG. 7 gives the computed attenuation of the ss_{b}⁰ mode over the range of membrane thickness d, showing that the attenuation increases slightly with membrane thickness—indicating increasing confinement to the strip 12. The attenuation remains low over the range of thicknesses shown.

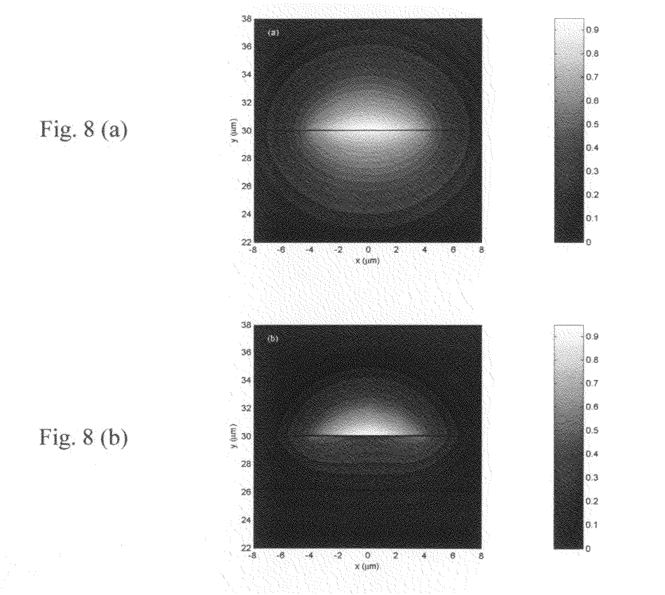

FIG. 8 gives the computed distribution of the normalized real part of the main transverse electric field component (Re{E_{y}}) of the ss_{b}⁰ mode over the waveguide cross-section for two specific waveguide geometries. Part (a) shows the distribution of Re{E_{y}} for the case w=8 μm, t=30 nm and d=1 nm, corresponding to the nominal situation where the membrane 14 is not optically invasive (i.e., effectively absent); the computed coupling loss to standard single mode fiber in this case was 1.54 dB. Part (b) shows the distribution of Re{E_{y}} for the case w=8 μm, t=30 nm and d=20 nm; the computed coupling loss to standard single mode fiber in this case was 1.06 dB.

Thus, when the free-space operating wavelength is set to 1550 nm, the membrane 14 is SiO₂, the strip is Au, and the environment is vacuum, dimensions of w=8 μm, t=30 nm and d=20 nm provide a preferred waveguide structure since the ss_{b}⁰ mode supported therein is well confined, has reasonably low loss and exhibits good coupling efficiency to standard single mode fiber. Also, the membrane 14 is thin enough to be optically not too invasive while being thick enough to be mechanically sound and provide adequate support.

### Example 2

The free-space operating wavelength was set to 1310 nm, SiO₂ (∈_{r,2}=1.44682) was selected as the material for the membrane 14, Au (∈_{r,3}=−86.08−j8.322) was selected as the material for the strip 12, and vacuum (∈_{r,1}=1) was selected for the environment E. The width w of the strip was set to 6 μm, its thickness t was set to 30 μm, and the thickness d of the membrane was varied from substantially 0 to about 55 nm for the purpose of illustrating its impact on the performance of the waveguide.

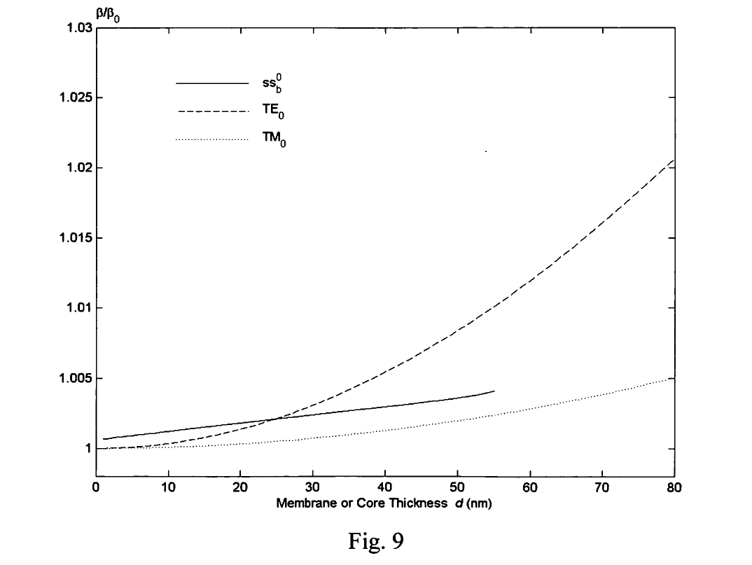

FIG. 9 gives the computed effective refractive index of the ss_{b}⁰ mode over the range of membrane thickness. The effective index of the TE₀ and TM₀ modes supported by the membrane 14 alone (i.e.: without the strip 12) was also plotted for reference.

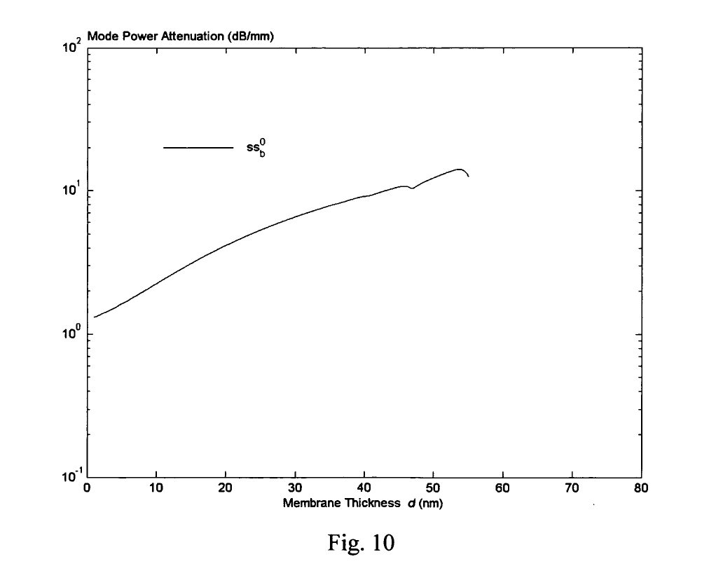

FIG. 10 gives the computed attenuation of the ss_{b}⁰ mode over the range of membrane thicknesses d, showing that the attenuation increases slightly with membrane thickness—indicating increasing confinement to the strip 12. The attenuation remains low over the range of membrane thicknesses shown.

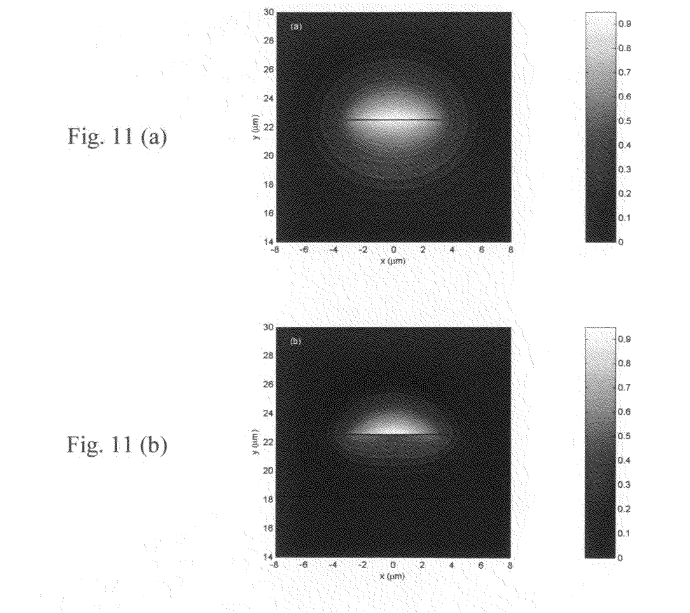

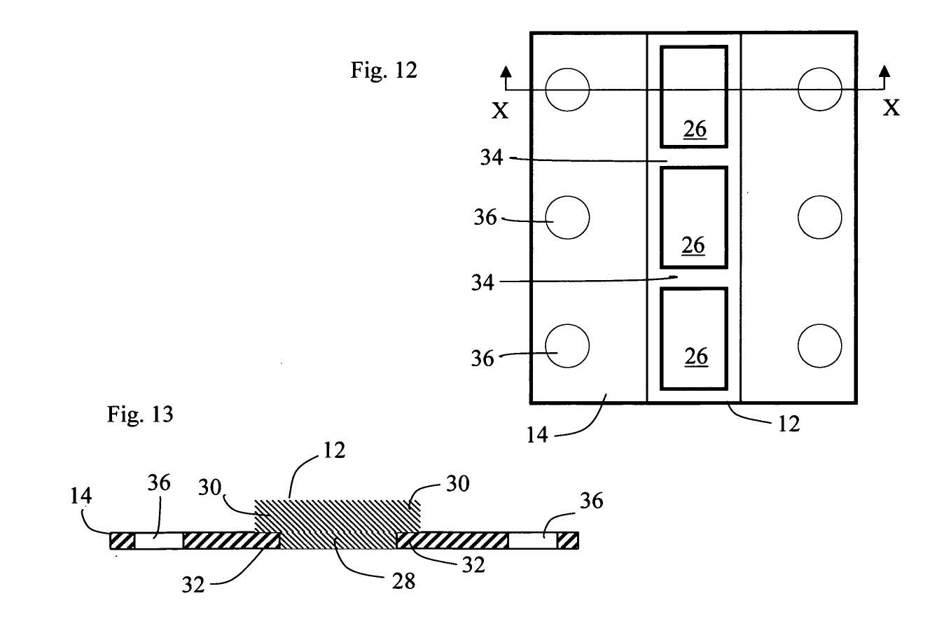

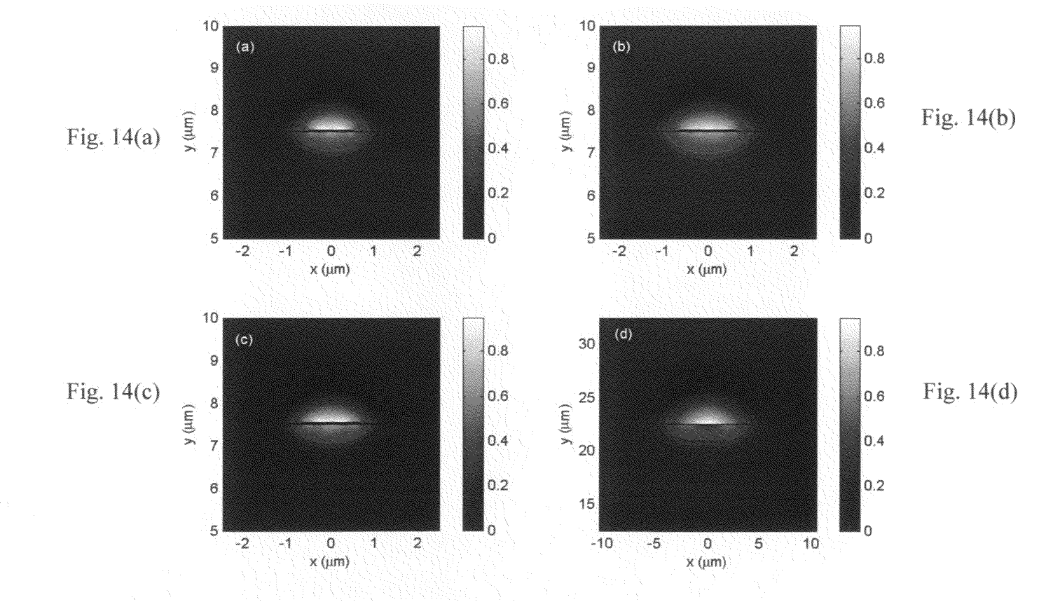

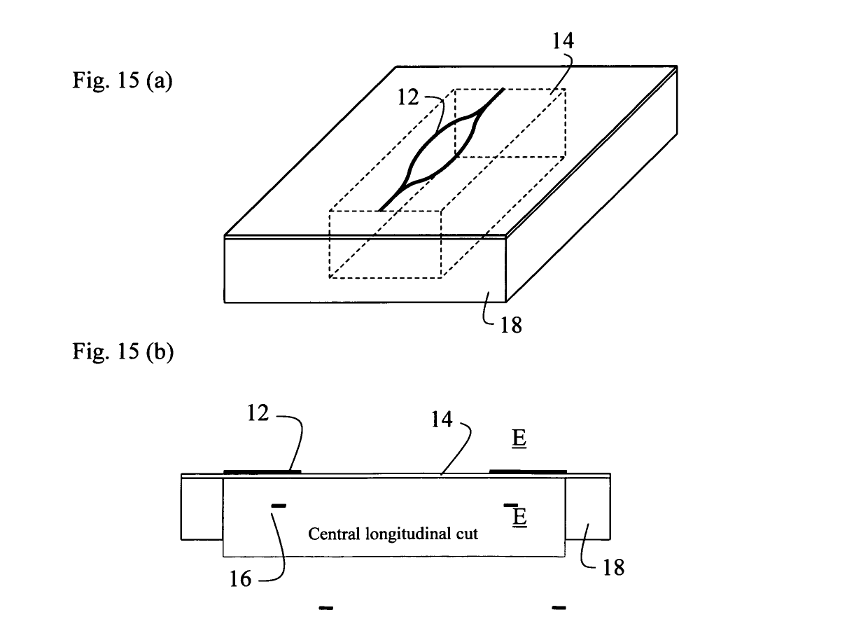

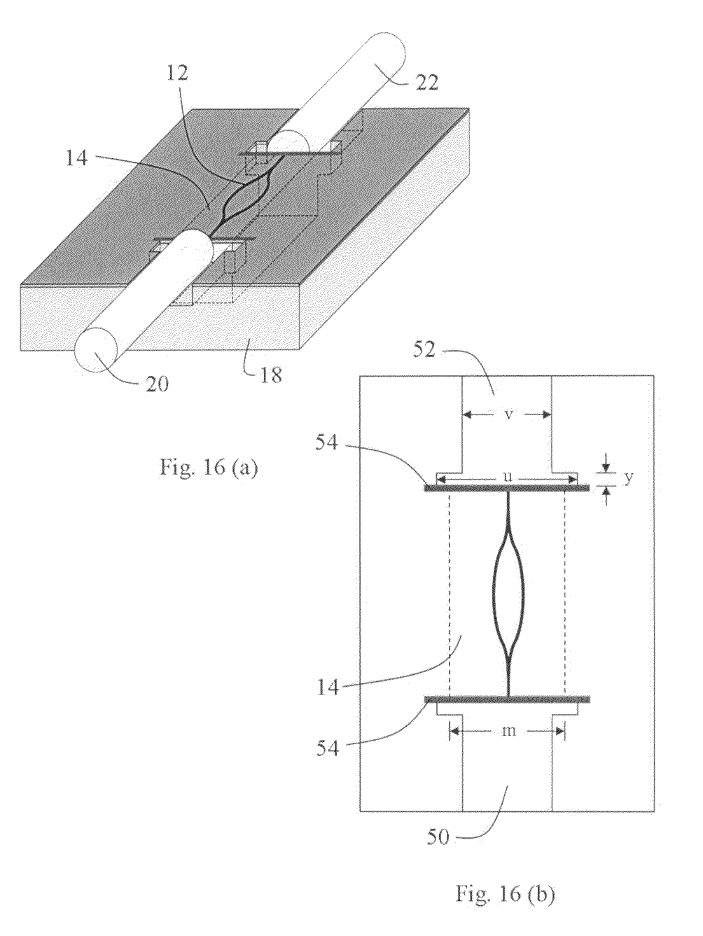

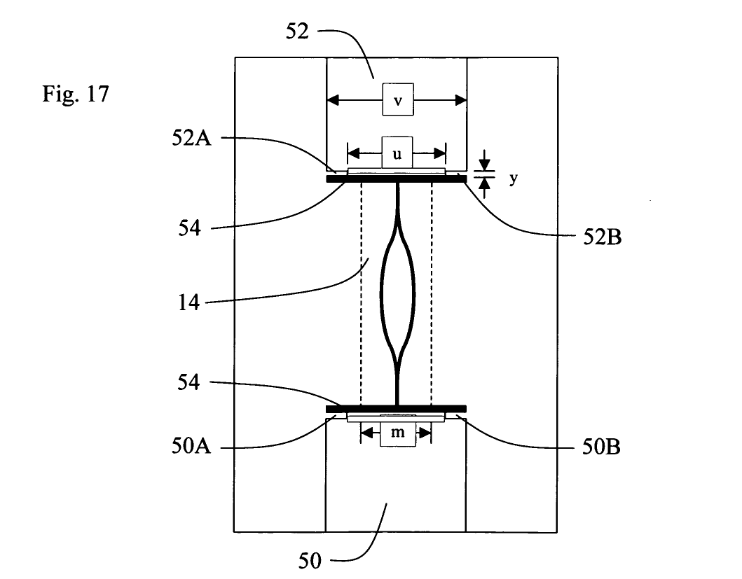

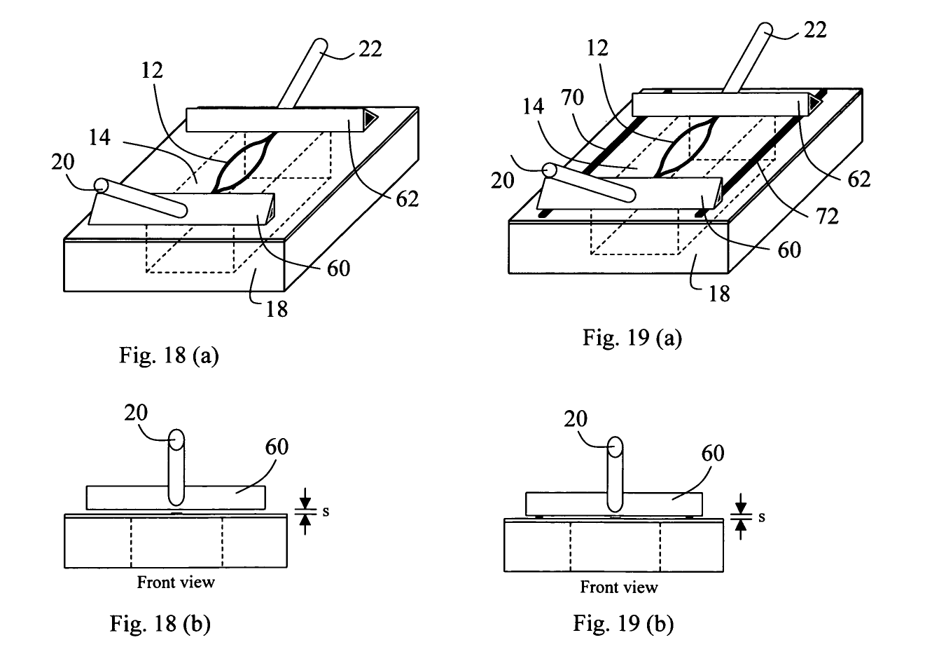

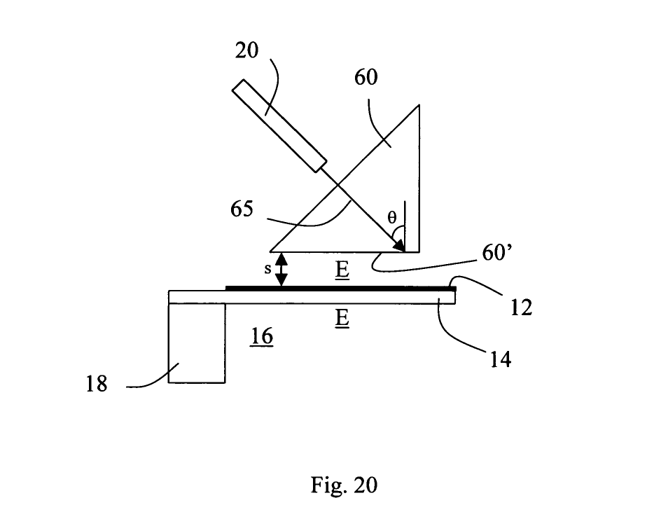

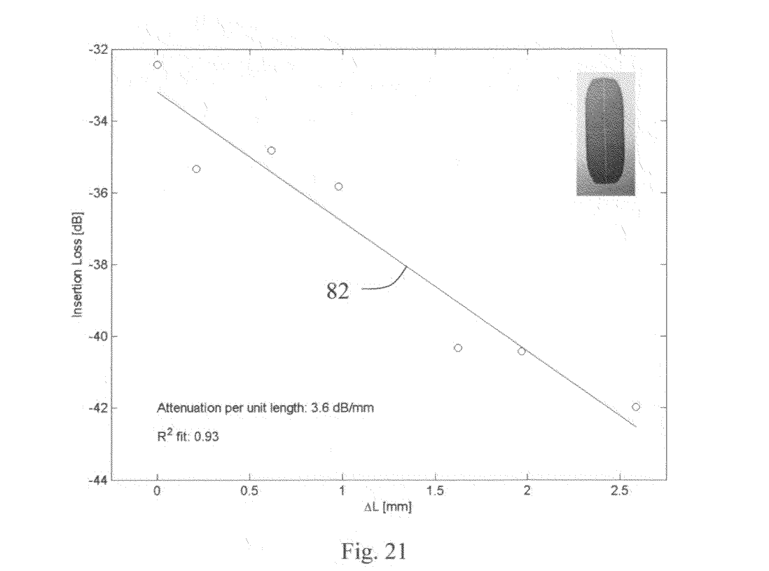

FIG. 11 gives the computed distribution of Re{E_{y}} over the waveguide cross-section for two specific waveguide geometries. Part (a) shows the distribution of Re{E_{y}} for the case w=6 μm, t=30 nm and d=1 nm, corresponding to the nominal situation where the membrane 14 is not optically invasive (i.e., effectively absent); the computed coupling loss to standard single mode fiber in this case was 0.59 dB. Part (b) shows the distribution of Re{E_{y}} for the case w=6 μm, t=30 nm and d=20 nm; the computed coupling loss to standard single mode fiber in this case was 0.49 dB.

Thus, when the free-space operating wavelength is set to 1310 nm, the membrane 14 is SiO₂, the strip 12 is Au, and the environment is vacuum, the dimensions w=6 μm, t=30 nm and d=20 nm provide a preferred embodiment of waveguide structure since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### Example 3

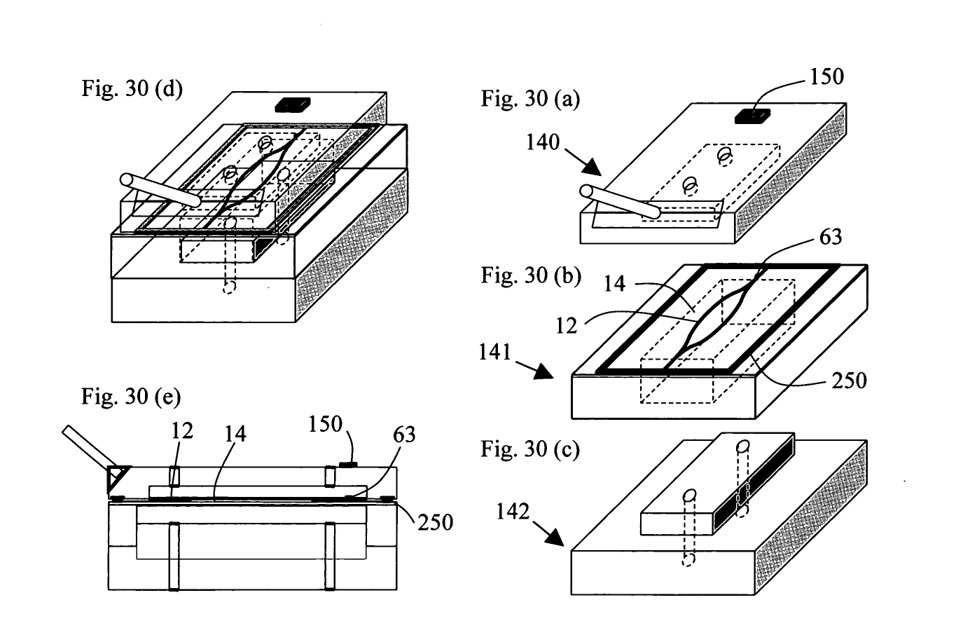

The free-space operating wavelength was set to 632.8 nm, Si₃N₄ (∈_{r,2}=2.0211²) was selected as the material of the membrane 14, Au (∈_{r,3}=−11.7851−j1.2562) was selected as the material of the strip 12, and vacuum (∈_{r,1}=1) was selected for the environment E. The width w of the strip 12 was set to 0.95 μm, its thickness t was set to 25 nm, and the thickness d of the membrane 14 was set to 20 nm. The computed effective refractive index of the ss_{b}⁰ mode was 1.00898, its attenuation was 4.39 dB/100 μm and its coupling loss to standard single mode fiber was 1.60 dB. For reference, the effective index of the TE₀ and TM₀ modes supported by the membrane 14 alone (i.e., without the strip 12) are 1.04412 and 1.00285, respectively. FIG. 30(a) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=0.95 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### Example 4

The free-space operating wavelength was set to 632.8 nm, Si₃N₄ (∈_{r,2}=2.02112) was selected as the material of the membrane 14, Au (∈ᵣ,3=−11.7851−j1.2562) was selected as the material of the strip 12, and vacuum (∈_{r,1}=1) was selected for the environment E. The width w of the strip 12 was set to 1.25 μm, its thickness t was set to 21 nm, and the thickness d of the membrane 14 was set to 20 nm. The computed effective refractive index of the ss_{b}⁰ mode was 1.00867, its attenuation was 3.03 dB/100 μm and its coupling loss to standard single mode fiber was 1.42 dB. For reference, the effective index of the TE₀ and TM₀ modes supported by the membrane 14 alone (i.e., without the strip 12) are 1.04412 and 1.00285, respectively. FIG. 30(b) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=1.25 μm, t=21 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### Example 5

The free-space operating wavelength was set to 632.8 nm, Si₃N₄ (∈_{r,2}=2.0211²) was selected as the material of the membrane 14, Au (∈_{r,3}=−11.7851−j1.2562) was selected as the material of the strip 12, and vacuum (∈_{r,1}=1) was selected for the environment E. The width w of the strip 12 was set to 1.25 μm, its thickness t was set to 25 nm, and the thickness d of the membrane 14 was set to 20 nm. The computed effective refractive index of the ss_{b}⁰ mode was 1.01094, its attenuation was 4.60 dB/100 μm and its coupling loss to standard single mode fiber was 1.90 dB. For reference, the effective index of the TE₀ and TM₀ modes supported by the membrane 14 alone (i.e., without the strip 12) are 1.04412 and 1.00285, respectively. FIG. 30(c) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=1.25 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### Example 6

The free-space operating wavelength was set to 1310 nm, Si₃N₄ (∈_{r,2}=2²) was selected as the material for the membrane 14, Au (∈_{r,3}=−86.08−j8.322) was selected as the material of the strip 12, and vacuum (∈_{r,1}=1) was selected for the environment E. The width w of the strip 12 was set to 5 μm, its thickness t was set to 25 nm, and the thickness d of the membrane 14 was set to 20 nm. The computed effective refractive index of the ss_{b}⁰ mode was 1.00169, its attenuation was 3.78 dB/mm and its coupling loss to standard single mode fiber was 0.58 dB. For reference, the effective index of the TE₀ and TM₀ modes supported by the membrane 14 alone (i.e., without the strip 12) are 1.01021 and 1.00065, respectively. FIG. 30(d) gives the computed distribution of Re{E_{y}} over the waveguide cross-section.

Thus, when the free-space operating wavelength is set to 1310 nm, the membrane 14 to Si₃N₄, the strip 12 to Au, and the environment to vacuum, the dimensions w=5 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### Adhesion Layer:

In the fabrication of waveguide structures, it might be desirable to use a thin adhesion layer, placed between strip 12 and membrane 14 in FIG. 4, in order to promote the adhesion of the strip 12 to the membrane 14. This would be particularly desirable when the strip material is, for example, Au and the membrane material is, for example, one of Si₃N₄, SiO₂ or SiON. In such cases, a suitable adhesion material is one of Cr, Ti or Mo, the adhesion layer would have the same width was the strip, and the adhesion layer would be 2 to 5 nm thick. It should be appreciated that this adhesion layer is not to be confused with the adlayer, where provided.

### Mechanical Support Means

The mechanical supports 18A and 18B (FIGS. 3 and 4) and 18L′, 18L″, 18R′; and 18R″ (FIG. 5) for supporting membrane 14, and the membrane 14 itself, may be fabricated on a Si wafer using standard lithography, deposition, and etching processes. Such processes are well-known to persons skilled in the fabrication arts and so will not be described in detail herein.

To ensure mechanical stability, the bottom surface of substrate 18 (FIGS. 3 and 4) or 18′ (FIG. 5) could be bonded to additional support means, for example a second Si wafer.

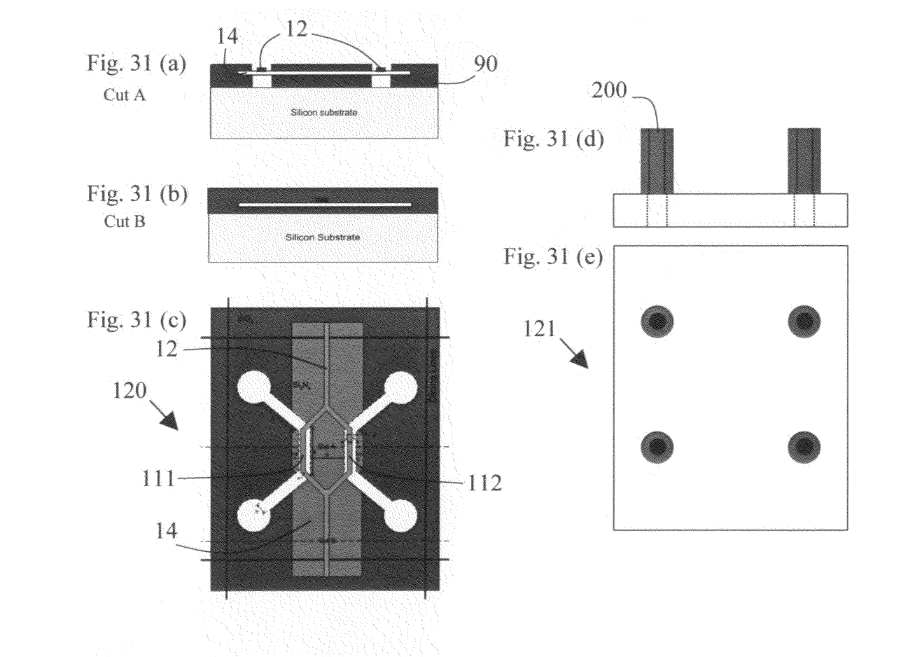

An alternative membrane waveguide structure is shown in isometric view in FIG. 31 (a), and in cross-sectional view taken along the longitudinal centre of the structure in FIG. 31 (b). In this embodiment, the membrane 14 is released from the substrate 18 by etching (for example) through the substrate material 18 to define cavity 16 shown in outline via the dashed lines in FIG. 31 (a) and in cross-sectional view in FIG. 31 (b). The cavity 16 is open at the bottom so that, in the region of the waveguide structure, the environment E is partitioned by the membrane 14 into optically semi-infinite portions, each portion extending away from the membrane 14 in the direction perpendicular to the plane of the membrane. The interior of the cavity 16 is in communication with the portion of the environment E at the opposite surface of the membrane 14, i.e., which carries the strip 12. Thus, the environment E is substantially the same each side of the strip 12 and membrane 14. In this alternative structure, the membrane is clamped all around and so is robust mechanically. A variant of this structure (not shown) has holes 36 in the membrane, as in FIG. 22, and a closed cavity 16 achieved by, say, bonding another substrate to the bottom surface of substrate 18.

The membrane in any of the embodiments need not have a rectangular shape when observed in plan view as suggested in FIGS. 3 and 31. Oval-like, elliptical-like or irregular shapes are also acceptable, as long as the width of the membrane m is always large enough to ensure that the substrate 18 remains optically non-invasive.

### Input and Output Means

As described hereinbefore, with reference to FIGS. 1, 2 and 4, appropriately designed waveguide structures embodying the present invention can be coupled efficiently with conventional dielectric waveguides 20, 22, say optical fibers, butt-coupled to the input and output ends of the waveguide structure. In order to achieve a high input coupling efficiency, the input waveguide 20 should be single-mode at the operating free-space wavelength, and its mode polarization-aligned and overlapping very well with the ss_{b}⁰ mode of the waveguide structure. Preferably, the input waveguide 20 is a polarization-maintaining single-mode fiber. The output waveguide 22 can be a polarization-maintaining single-mode fiber, a multimode fiber, or preferably, a standard single-mode fiber.

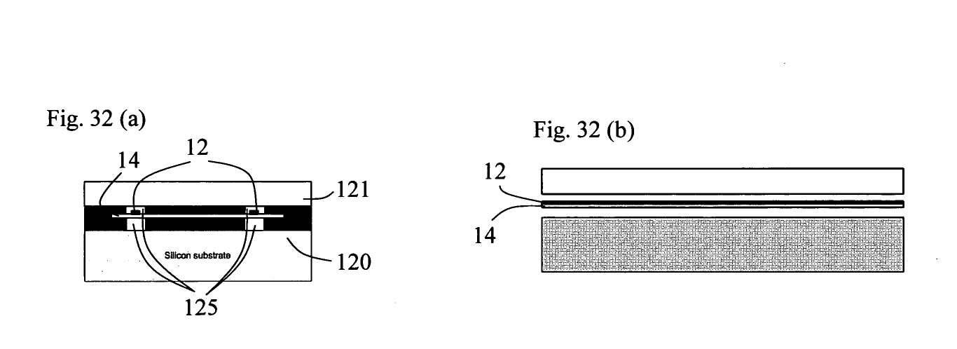

A similar waveguide structure is shown in isometric view in FIG. 32 (a) and in top view in FIG. 32 (b), where the input and output fibers 20 and 22 are placed within input and output trenches 50 and 52 etched through the top surface of the structure into the substrate 18. The width v of the trenches is selected to be slightly larger than the diameter of the fibers and their depth is set to half of this size. The dimensions of the fabricated trenches are accurate since the trench widths are controlled lithographically and their depths and verticality through the etching process, so they can be used to precisely align the fibers to the waveguide structure. If desired, the trenches can be widened to a width u over a length y of a few microns near the membrane of width m. This could be helpful from the fabrication standpoint.

FIG. 32 (c) shows a case where the membrane width m is less than the trench width v, consequently, the width u can be set greater than m but less than v. Advantageously, portions 50A, 50B, 52A and 52B are thus defined, serving to stop the input and output fibers 20 and 22 (not shown) from contacting the membrane 14. Optionally, strength members 54 can be added, spanning the width of the unattached ends of the membrane 14, if additional strength is desired. The strength members are a few microns wide and a few microns thick and could be comprised of any of the materials identified for the membrane. Such strength members would not be too invasive optically.

It is also envisaged, however, that optical radiation could be coupled into and/or out of the waveguide structure via the top surface, for example by means of a prism coupler, or by means of a grating or scattering means (or many scattering means) patterned on or within a portion of the strip 12, as will be described in more detail hereinafter.

FIG. 33(a) shows, for example, an arrangement of two prism couplers 60 and 62 with input and output fibers 20 and 22 used to interface with the waveguide structure via the top surface. The arrangement is shown in frontal view in FIG. 33 (b) and as a partial longitudinal cut through the centre of the input fiber, input prism and waveguide structure in FIG. 34. As shown in FIG. 34, the input fiber 20 is aligned such that the p-polarized input light beam 65 is incident onto the bottom surface 60′ of input prism 60 at an angle of incidence of θ and near the right angle corner of the prism. The prism is spaced a distance s from the strip 12 of the waveguide structure.

The spacing s and the angle of incidence θ needed for optimum coupling between the incident p-polarized beam 65 and the ss_{b}⁰ mode supported by the waveguide structure are readily determined via computation using a plane wave model given the operating free space wavelength, the materials chosen for the strip 12 and the membrane 14, and the environment E. A lens, or a system of lenses, could be inserted between the fiber 20 and the prism 60 in order to collimate, focus or otherwise shape the incident beam 65.

The output prism 62 and output fiber 22 are arranged in an identical but reversed (or mirrored) manner to the input, as suggested in FIG. 33 (a), and a lens or a system of lenses could likewise be inserted between the fiber 22 and the prism 62. The arrangement at the input and output is such that the input and output beams couple with the ss_{b}⁰ mode at a location along the membrane waveguide structure where the substrate 18 is optically non-invasive, as suggested for the input in FIG. 34. FIGS. 33(c) and (d) show optional rails 70 and 72, added to the waveguide structure in order to facilitate accurate spacing of the prisms relative to the strip 12. The rails 70, 72 have the precise thickness s required to achieve the optimal optical coupling. Alternatively, small pedestals of thickness s could be added to the bottom surfaces of the prisms 60 and 62 for the same purpose. Any of the materials listed for the membrane and for the strip, could be used for the rails 70 and 72 and for said pedestals. Alternatively, any other convenient material can be used or any micro-object having the correct size can be used.

### Example 7

In the case of the preferred embodiment and conditions described under Example 6, it was computed, using a plane wave model, that almost 100% coupling would occur between the p-polarised incident wave and the ss_{b}⁰ mode using a prism comprised of BK7 (n=1.5036 at 1310 nm) spaced a distance s of 2 to 7 μm away from the Au strip and with the beam incident at an angle θ of about 41.7 to 41.9 Deg. Particularly good values are s=4.2 μm and θ=41.85 Deg.

### Example 8

A straight waveguide structure corresponding to the preferred embodiment described under Example 6, except that 2 nm of Cr was used as an adhesion layer followed by 23 nm of Au, and implemented as the clamped membrane shown in FIG. 31, was fabricated using Si as the substrate 18. A microscope image of a typical fabricated structure is shown as the inset to FIG. 36. The waveguide was operated under conditions similar to those described under Example 6, by allowing the ambient air (∈_{r,1}˜1) as the environment E to surround the waveguide structure. The ss_{b}⁰ mode was successfully excited along this structure using an input prism and an input single mode fiber, in the arrangement depicted in FIG. 33(a) and FIG. 34, and according to Example 7 with s˜4.2 μm and θ˜41.85 Deg.

In keeping with the well-known cut-back technique, the fiber to fiber insertion loss was measured for various lengths of waveguide, and the measurements are shown as the open circles on the linear plot in FIG. 36 (ΔL corresponds to the distance between a measurement point and the first measurement). The best fitting (least squares) linear model 82 is also plotted for reference. The data and model have an R² correlation of 0.93 (R is the Pearson product-moment correlation coefficient). The slope of the linear model yields the measured attenuation, which is 3.6 dB/mm, in very good agreement with theory as can be deduced by comparison with the computation given under Example 6.

FIG. 37 gives an example of the coupling means comprising a scattering means 63 defined lithographically on top of the strip 12, and an optical output fiber 22 used to collect at least a portion of the scattered light. The scattering means 63 and fiber 22 are convenient for monitoring the level of power at a particular location along the waveguide structure. The scattering means 63 may take the form of a parallelepiped, as shown, or various other shapes, such as a cylindrical or triangular rod. The scattering means 63 may or may not be centered on the strip 12. An apex of the center might also be aligned with the central axis of the strip. The thickness of the centre is selected such that its cross-sectional area overlaps with a good part of the mode, good values for its area being about 5 to 50% of the mode area. Thus, a thickness in the range of 0.1 to 3 μm is suitable for centers used with the preferred embodiments described under Examples 1 to 6. Any of the materials listed for the membrane or the strip may be used. Alternatively, any other convenient material can be used or any micro-object having the appropriate size can be used. Preferably the material is a metal. The output optical fiber 22 can be a polarization-maintaining single-mode fiber, a multimode fiber, a standard single-mode fiber, or a high numerical aperture fiber.

In FIG. 37, the scattering means 63 is shown upon the central portion of membrane 14 that extends across the mouth of cavity 16. It should be appreciated, however, that the scattering means 63 could be positioned on a margin portion of the membrane 14 overlying the substrate 18, aligned with and close to the distal end of strip 12. The output waveguide 22 would be displaced outwards as required to ensure collection of the scattered light.

### Example 9

Such a scattering means in the form of a parallelepiped 1.25 μm thick, 4 μm wide by 4 μm long was deposited onto the strip 12 of a waveguide structure similar to that described under Example 8, but with the scattering means 63 positioned on the margin of membrane 14 and the output waveguide 22 moved outwards. The waveguide was operated under the same conditions as in Example 8, with the excitation provided in like manner by an input prism coupler 60 and an input fiber 20. Light in the ss_{b}⁰ mode propagating along the waveguide was observed to scatter from the scattering means 63. The scattered light was collected first by an infrared camera through an optical microscope, then by a multimode fiber aligned perpendicularly to the scattering means 63 at a distance of about 15 μm, and finally by a single-mode fiber also aligned perpendicularly to the scattering means at a distance of about 15 μm. The optical output powers collected were sufficiently high to be useful in a monitoring function.

A chain of scattering means can be arranged to form an input or output grating coupler, which when excited with p-polarised light at the appropriate angle of incidence results in efficient energy transfer with the ss_{b}⁰ mode of the waveguide.

It should be appreciated that, when it is stated that the membrane 14 must be “not too invasive optically”, the level of “invasiveness” that can be tolerated or will, in fact, be desired will depend upon the particular application. In some cases, the degree of optical invasiveness should be minimal, i.e., the membrane 14 should have minimal effect upon the propagation of the plasmon-polariton wave. In other cases, however, for example surface sensors, a degree of invasiveness is, in fact, beneficial, as will be explained hereafter.

### Surface Sensor:

Observing the mode field distributions shown in FIGS. 8, 11 and 30, computed in the case of the Examples 1-6, reveals that the presence of the membrane 14 perturbs the mode such that it becomes more tightly confined to the strip 12 and that its fields become localized to its top surface (i.e.: to the surface of the strip not in contact with the membrane 14 but rather in contact with the environment E). Consider Example 2, for instance, and compare FIG. 11(a) with FIG. 11(b), which show the computed distribution of Re{E_{y}} over the waveguide cross-section for the cases d=1 nm and d=20 nm, respectively: FIG. 11(a), which corresponds to the nominal situation where the membrane 14 is effectively optically absent, shows the mode field (Re{E_{y}}) symmetrically distributed over the waveguide cross-section; FIG. 11(b), which corresponds to the situation where the membrane 14 is sufficiently thick to perturb the mode, shows the aforementioned localization and increased confinement compared to FIG. 11(a).

The increased confinement and localization of the mode fields to the top surface of the strip are beneficial to certain sensing applications. For example, a thin layer 100 adhered to this surface (e.g.: an adlayer) as shown in FIG. 38(a), and which changes in response to changes in the environment E or to changes in the concentration of a gaseous species (i.e.: the analyte) distributed within the environment, can be used. The adlayer could, for example, comprise a receptor molecule that is chemically specific to a particular analyte, or it might comprise a material, such as a polymer, that is chemically sensitive (or reactive) to a particular gas within the environment. Many polymers, for example, are known to swell as they absorb water vapour from the air and hence could be used as the adlayer to enable a humidity sensor. Alternatively, instead of using an adlayer, the material used for the strip 12 may be selected for its chemical sensitivity to a particular gas (FIG. 38 (b)). Ag for example is known to react with S, Cu and Al with O₂ and Pd absorbs H₂. Hence, selecting these metals (or alloys thereof) for the strip leads to S, O₂ and H₂ sensors.

### H₂ Sensor:

It is known that Pd and Pd-rich alloys are particularly well-suited as chemical to physical transduction materials for H₂ sensors [1-19]. H₂ is highly soluble in Pd and Pd is highly selective to H₂. H₂ absorption into Pd proceeds in three steps: (i) adsorption of H₂ molecules on the Pd surface, (ii) disassociation of the H₂ molecules by the Pd surface, and (iii) diffusion of H into Pd forming palladium hydride —PdHₓ, where x is the atomic ratio H/Pd. The H content of PdHₓ (i.e.: x) is in thermodynamic equilibrium with the environment, so x decreases as the H₂ concentration in the environment is reduced. Hence the H absorption process is in principle reversible. As the H₂ concentration in the environment increases, x increases, inducing a change in the lattice constant and bandstructure of PdHₓ, and hence inducing changes in the physical properties (e.g.: electrical conductivity and optical parameters) of the material. From the pressure—composition isotherms of PdHₓ it is observed that below about 300° C. and in the absence of H₂, Pd is always in the α-phase, and that when exposed at room temperature to ˜1 atm of H₂ it forms PdH_{0.65} which is in the γ-phase. At room temperature and atmospheric pressure the α-phase extends to x=0.03, the β-phase occurs above x=0.6 and a mixed αβ-phase occurs in between. In the mixed αβ-phase region, small changes in H₂ concentration cause large changes in composition and thus in physical properties. At room temperature x=0.03 for 2% H₂ (i.e.: at a partial pressure of 2-2.7 kPa or 15 to 20 Torr) so the phase transition occurs just below the lower explosive limit for H₂ in air.

The optical parameters n and k (recall that the relative permittivity ∈ᵣ is related to the optical parameters via ∈ᵣ=N²=(n−jk)²) of Pd and β-phase PdHₓ have been measured using ellipsometry for a 10 nm thick Pd film exposed to H₂ [13]. The β-phase PdHₓ was created from exposure to 100% H₂ at ˜1 atm at room temperature. The optical parameters of the resulting PdHₓ were found to change from those of Pd as follows: k(PdHₓ)/k(Pd)˜0.73 and n(PdHₓ)/n(Pd)˜0.97 at λ₀˜632.8 nm; k(PdHₓ)/k(Pd)˜0.71 and n(PdHₓ)/n(Pd)˜0.86 at λ₀=750 nm; k(PdHₓ)/k(Pd)˜0.89 and n(PdHₓ)/n(Pd)˜0.70 at λ₀˜1310 nm; k(PdHₓ)/k(Pd)˜0.91 and n(PdHₓ)/n(Pd)˜0.75 at λ₀=1500 nm. Hence the measurements indicate that both n and k decrease with x. The permittivity of PdHₓ as a function of x can be modelled empirically as [12]: ∈_{r,PdHx}(c)=h(c)∈_{r,Pd} where c is the concentration of H₂ gas in the environment and h(c) is a scalar function in the approximate range 0.5≦h(c)≦1 with h(c)=1 for x=0. This model agrees qualitatively with the measurements.

The change in lattice constant associated with the α- to β-phase transition in PdHₓ can lead to irreversible operation (hysteresis) and failure of the Pd film, especially for repeated absorption/desorption cycles through the phase transition. Other consequences of cycling through the phase transition include increased roughness, blistering and eventually delamination of the film. Alloying with another metal alters the pressure—composition isotherms and the phase transition can be moved to higher H₂ concentrations and pressures (the composition x retains the same definition for alloys; e.g.: Pd_{1-y}Ni_{y}Hₓ where x is the atomic ratio H/Pd_{1-y}Ni_{y}).

Alloying with 8 to 10% Ni is a good choice since adding Ni contracts the lattice compared to pure Pd, which reduces the solubility of H leading to a slightly reduced sensitivity, but inhibits the transition to the β-phase over a useful thermal and pressure range of operation, leading to reversible operation (no hysteresis), greater reliability and a larger dynamic range. For example, Pd_{0.92}Ni_{0.08} exhibits no phase transition when exposed to 100% H₂ at 1 atm and 300 K. It is also noteworthy that Pd_{0.44}Ni_{0.56} exhibits no response to H₂ and so can be used as a reference since the temperature coefficient of resistance (and hence its thermo-optic coefficient dN/dT) is comparable among PdNi alloys. PdNi films also show a high degree of immunity to interfering gases: Pd_{0.92}Ni_{0.08} exhibits low sensitivity and resists poisoning from 100 ppm of H₂S; Pd_{0.94}Ni_{0.06} exhibits low sensitivity to 500 ppm of CO and 2.6% of CH₄; Pd_{0.90}Ni_{0.10} exhibits low sensitivity to 100 ppm of NO₂, 1000 ppm of CO, 70 ppm of NH₃, 100 ppm of SO₂ and 1 ppm of Cl₂. Operating the film near 50° C. instead of near room temperature desorbs H₂O (and other contaminants) from the surface, and reduces aging and interference effects but also reduces the response time and sensitivity.

Hence, for hydrogen sensors, it is of interest to understand how changes in the optical properties of Pd might confer changes to the ss_{b}⁰ mode propagating along the waveguide, under two example waveguide scenarios: (i) a thin adlayer of Pd 100 located on the top surface of an Au strip 12 in the configuration shown in FIG. 38(a), and (ii) the strip 12 comprised entirely of Pd in the configuration shown in FIG. 38(b). In order to gain this understanding, computer modeling techniques, as described above for Examples 1-6, were used to analyse waveguide structures and to determine the ss_{b}⁰ mode sensitivities. The sensitivity of the effective index (n_{eff}=β/β₀) and of the mode power attenuation (MPA) of the ss_{b}⁰ mode to changes in the thickness or relative permittivity of the Pd layer are of interest. Under scenario (i) these sensitivities are denoted: ∂n_{eff}/∂a, ∂n_{eff}/∂h(c), ∂MPA/∂a and ∂MPA/∂h(c). Under scenario (ii) these sensitivities are denoted: ∂n_{eff}/∂t, ∂n_{eff}/∂h(c), ∂MPA/∂t and ∂MPA/∂h(c). The term h(c) in these sensitivities refers to the aforementioned scalar function that models empirically the change in the permittivity of PdHₓ with x (i.e.: ∈_{r,PdHx}(c)=h(c)∈_{r,Pd}).

### Example 10

### Scenario (i)—FIG. 38 (a)

The free-space operating wavelength was set to 1310 nm, Si₃N₄ (∈_{r,2}=2²) was selected as the material for the membrane 14, Au (∈_{r,3}=−86.08−j8.322) was selected as the material for the strip 12, vacuum (∈r,1=1) was selected as the environment E, and a Pd (∈_{r,4}=−45.8154−j39.9284) adlayer 100 of thickness a=15 nm was used. The width w of the strip 12 and adlayer 100 were set to w=5 μm, the thickness t of the strip 12 was set to t=25 nm and the thickness d of the membrane 14 was set to d=20 nm. The computed effective refractive index of the ss_{b}⁰ mode was 1.00348, its attenuation was 6.64 dB/100 μm and its coupling loss to standard single mode fiber was 0.7 dB. For reference, the effective index of the TE₀ and TM₀ modes supported by the membrane 14 alone (i.e., without the strip 12 and adlayer 100) are 1.01021 and 1.00065, respectively.

The computed sensitivities are: ∂n_{eff}/∂a=1.1×10⁻⁴ nm⁻¹, ∂MPA/∂a=0.64 dB/(100 μm·nm), ∂n_{eff}/∂h(c)=2.1×10⁻³ and ∂MPA/∂h(c)=−5.9 dB/100 μm. It is noted that the n_{eff} sensitivities add while the MPA sensitivities subtract with H absorption (the Pd adlayer thickness increases and its permittivity decreases with x). FIG. 50 gives the computed distribution of Re{E_{y}} over the waveguide cross-section.

Thus, when the free-space operating wavelength is set to 1310 nm, the membrane 14 to Si₃N₄, the strip 12 to Au, the adlayer to Pd and the environment to vacuum, the dimensions w=5 μm, t=25 nm, d=20 nm and a=15 nm provide a waveguide structure that is a preferred embodiment since the ss_{b}⁰ mode supported therein is well confined, has reasonably low loss, exhibits good coupling efficiency to standard single mode fiber and is very sensitive to H absorption within the Pd adlayer, using a membrane 14 that is thin enough to be optically not too invasive while being thick enough to be mechanically sound and provide adequate support.

### Example 11

### Scenario (ii)—FIG. 38 (b)

The free-space operating wavelength was set to 1550 nm, SiO₂ (∈_{r,2}=1.444²) was selected as the material for the membrane 14, Pd (Σ_{r,3}=−60.6764−j49.1799) was selected as the material for the strip 12 and vacuum (∈_{r,1}=1) was selected for the environment E. The width w of the strip 12 was set to infinity and its thickness t was varied over the range 10≦t≦80 nm, while the thickness d of the membrane 14 was varied over the range 1≦d≦80 nm.

FIG. 39 gives the computed sensitivity ∂MPA/∂h(c) in dB/10 μm of the ss_{b}⁰ mode over these ranges of strip and membrane thickness t and d. The sensitivity ∂MPA/∂t was also computed and found to be smaller than that relative to h(c). The computed sensitivities are plotted as solid gray-scaled constant-valued contours. The associated mode power attenuation (MPA) is also plotted in dB/10 μm for reference as the labeled dash-dot constant-valued contours. The effective refractive index of the TE₀ mode supported by the membrane 14 alone (i.e.: without the strip) is added as diamonds for a few thicknesses d.

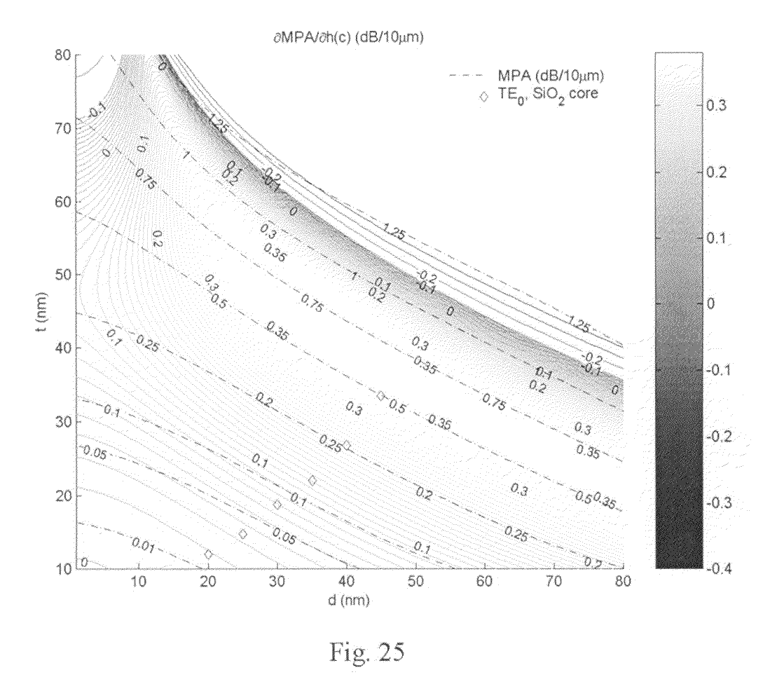

From FIG. 25 it is observed that the largest sensitivity ∂MPA/∂h(c) is about 0.35 dB/10 μm and that it occurs near t=45 nm and d=35 nm. Hence these values for t and d represent a preferred embodiment. Based on this plot, it is recognized that the ratio of ∂MPA/∂h(c) to MPA (i.e.: (∂MPA/∂oh(c))/MPA) is greatest over the ranges of t=20 to 50 nm and d=20 to 70 nm. Hence other preferred embodiments of this example will have t and d within these ranges. For instance, values of t and d near 25 and 35 nm, respectively, are particularly preferred as they lead to efficient (lower loss) operation. The results plotted in FIG. 25 do not change very much with strip width w, as long as it remains greater than about 5 μm.

### Example 12

### Scenario (ii)—FIG. 38 (b)

The free-space operating wavelength was set to 1550 nm, SiO₂ (∈_{r,2}=1.444²) was selected as the material for the membrane 14, Pd (∈_{r,3}=−60.6764−j49.1799) was selected as the material for the strip 12 and vacuum (∈_{r,1}=1) was selected for the environment E. The width w of the strip 12 was set to infinity and its thickness t was varied over the range 10≦t≦80 nm, while the thickness d of the membrane 14 was varied over the range 1≦d≦80 nm.

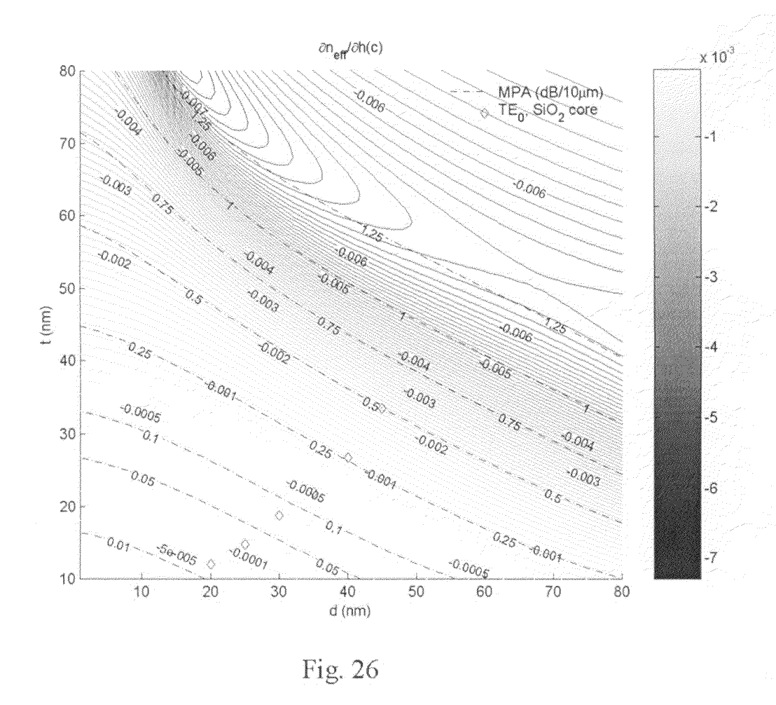

FIG. 26 gives the computed sensitivity ∂n_{eff}/∂h(c) of the ss_{b}⁰ mode over these ranges of strip and membrane thickness t and d. The sensitivity ∂n_{eff}/∂t was also computed and found to be smaller than that relative to h(c). The computed sensitivities are plotted as solid gray-scaled constant-valued contours. The associated mode power attenuation (MPA) is also plotted in dB/10 μm for reference as the labeled dash-dot constant-valued contours. The effective refractive index of the TE₀ mode supported by the membrane 14 alone (i.e.: without the strip) is shown (as diamonds) for a few thicknesses d.

From FIG. 26 it is observed that the largest sensitivity ∂n_{eff}/∂h(c) is about −7×10⁻³ and that it occurs near t=70 nm and d=25 nm. Hence these values for t and d represent a preferred embodiment. Based on this plot, it is recognized that the ratio of ∂n_{eff}/∂h(c) to MPA (i.e.: (∂n_{eff}/∂h(c))/MPA) is greatest over the ranges of t=40 to 80 nm and d=15 to 60 nm. Hence other preferred embodiments of this example will have t and d within these ranges. For instance, values of t and d near 70-80 and 15-25 nm, respectively, are particularly preferred, leading to efficient operation. The results plotted in FIG. 26 do not change very much with strip width w, as long as it remains greater than about 5 μm.

In light of the foregoing discussion and based on the results given under Examples 10, 11 and 12, it is noted that these waveguides are preferred embodiments for hydrogen sensing since the structures exhibit a high sensitivity combined with a low mode power attenuation.

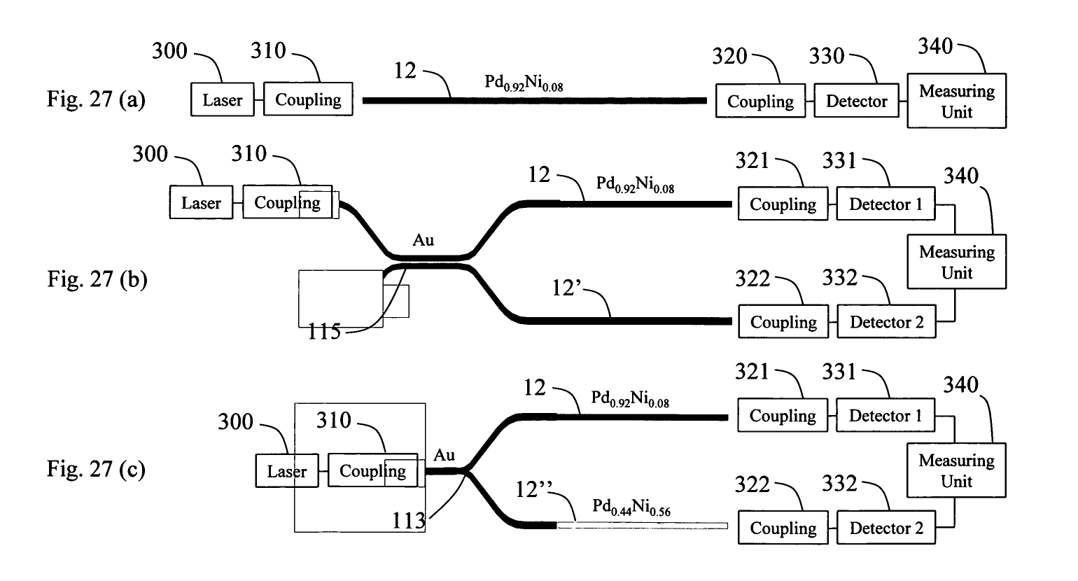

The change in the MPA (ΔMPA) of the ss_{b}⁰ mode, due to the absorption of H in a Pd adlayer 100 or in a Pd strip 12, is written ΔMPA=Δh(c)·∂MPA/∂h(c). This change in MPA (ΔMPA) leads to a change in the insertion loss of a waveguide section. Structures for which it is convenient to monitor the insertion loss are shown in FIG. 27. Such structures are termed “attenuation-based” H₂ sensors.

### Example 13

FIG. 27(a) shows schematically a straight waveguide sensor comprising a Pd_{0.92}Ni_{0.08} strip 12 (or adlayer 100) as the H₂ sensing medium. Optical radiation, specifically light from a laser 300, is coupled by way of input coupling means 310, for example an optical fiber, prism or other suitable device, to one end of the strip 12. A suitable output coupling means 320 extracts the light from the other end of the strip 12 and conveys it to a detector 330. The corresponding electrical signal from the detector is processed by a measuring unit 340 which, typically, will comprise a microprocessor with an analog-to-digital converter for converting the analog electrical signal to a digital signal representing the output optical power of the light leaving the strip 12.

The optical insertion loss of this sensor changes as H₂ absorbs into the Pd_{0.92}Ni_{0.08} strip 12. Changes in insertion loss cause changes in the output optical power measured by the optical detector 330. Hence, the measuring unit 340 monitors the output optical power over time and compares it against its initial value (e.g.: prior to exposure to H₂). A prescribed change in this power is taken as an indication that H₂ is present in the environment.

### Example 14

FIG. 27(b) shows schematically a sensor comprising a laser source 300 and input means 310 similar to those shown in FIG. 27(a) but further comprises an input coupler 115 connected to the input means. One output of the input coupler 115 is connected to the input end of the Pd_{0.92}Ni_{0.08} strip 12 (or adlayer 100) which is the H₂ sensing medium. A Au strip 12′ is connected to the other output of the coupler 115. The output of the sensing strip 12 is connected via output coupling means 321, such as another optical fiber or a prism, to a first detector 331, as in the example of FIG. 27(a). The output of the second strip 12′ is connected via second coupling means 322 to a second detector 332. The outputs of both detectors are connected to measuring unit 340.

The operation of this sensor is similar to that of the previous example in that the insertion loss along the path that includes the Pd_{0.92}Ni_{0.08} strip 12 changes with the absorption of H₂. However, the insertion loss along the other path, which includes the Au strip 12′ only, does not. Hence, the optical power measured by detector 1 changes with H₂ absorption, while that measured by detector 2 does not. This configuration confers additional advantages over the single output version shown in FIG. 27(a) in that source and input coupling fluctuations can be rejected from the measurement by referencing (i.e.: forming the ratio of) the optical power measured by detector 1 to that measured by detector 2. Hence, the measuring unit 340 monitors the ratio between the measured output optical powers over time and compares it against its initial value (e.g.: prior to exposure to H₂). A change is this ratio is taken as an indication that H₂ is present in the environment.

### Example 15

FIG. 27(c) shows schematically a sensor comprising a laser source 300 and input means 310 similar to those shown in FIG. 27(a) but further comprises an input Y-junction splitter 113 connected to the input means. One output of the input Y-junction splitter is connected to the input end of the Pd_{0.92}Ni_{0.08} strip 12 (or adlayer 100) which is the H₂ sensing medium. A Pd_{0.44}Ni_{0.56} strip 12″, which is insensitive to H₂, is connected to the other output of the Y-junction splitter 113. The output of the sensing strip 12 is connected via output coupling means 321 to a first detector 331, as in the example of FIG. 27(a). The output of the second strip 12″ is connected via second coupling means 322 to a second detector 332. The outputs of both detectors are connected to measuring unit 340.

The operation of this sensor is similar to that of the previous example in that the insertion loss along the path that includes the Pd_{0.92}Ni_{0.08} strip 12 changes with the absorption of H₂. However, the insertion loss along the other path, which includes the Pd_{0.44}Ni_{0.56} strip 12″, does not. Hence, the optical power measured by detector 1 changes with H₂ absorption, while that measured by detector 2 does not. This configuration confers additional advantages over the previous example in that source and input coupling fluctuations as well as thermal fluctuations can be rejected from the measurement by referencing (i.e.: forming the ratio of) the optical power measured by detector 1 to that measured by detector 2. Advantageously, the mode power attenuation of the Pd_{0.92}Ni_{0.08} and Pd_{0.44}Ni_{0.56} strips change similarly with temperature (i.e.: these alloys have a similar dN/dT). Hence, the measuring unit 340 monitors the ratio between the measured output optical powers over time and compares it against its initial value (e.g.: prior to exposure to H₂). A change is this ratio is taken as an indication that H₂ is present in the environment.

The change in insertion loss AIL in dB of the H₂ sensing segment in Examples 13 to 15 is given by: ΔIL=IL₀·Δh(c)·(∂MPA/∂h(c))·(1/MPA) where IL₀ in dB corresponds to the nominal insertion loss of the segment prior to exposure to H₂. Given this equation, it is clear that maximizing the ratio (∂MPA/∂h(c))/MPA), as discussed with respect to the preferred embodiments in Example 11, is desirable.

### Example 16

Based on Example 11 and FIG. 25, membrane and strip thicknesses of d=35 nm and t=25 nm are selected, respectively, leading to values of ∂MPA/∂h(c)=14.65 dB/mm, MPA=18.11 dB/mm, and hence (∂MPA/∂h(c))/MPA=0.81 which is a near optimal ratio. Choosing a nominal insertion loss of IL₀=35 dB, assuming a minimum detectable change in insertion loss of 0.001 to 0.0001 dB, and using ΔIL=IL₀·Δh(c)·(∂MPA/∂h(c))·(1/MPA), leads to a detection limit of Δh(c)ₘᵢₙ=3.5×10⁻⁵ to 3.5×10⁻⁶ and hence a detection limit in H₂ concentration of Δcₘᵢₙ˜3.5 to 0.35 ppm.

The change in the effective index Δn_{eff} of the ss_{b}⁰ mode, due to the absorption of H in a Pd adlayer 100 or in a Pd strip 12, is written Δn_{eff}=Δh(c)·∂n_{eff}/∂h(c). This change in effective index Δn_{eff} leads to a change in the insertion phase of the waveguide which can be detected by combining its output mode field with that emerging from an identical waveguide that is used as a reference and is made to not undergo a phase shift, and detecting the power of the resulting combination. A structure that is convenient for achieving this is the Mach-Zehnder interferometer, well-known from the art of conventional integrated optics. Also, a Mach-Zehnder interferometer implemented using a plasmon-polariton waveguide structure is disclosed in U.S. Pat. Nos. 6,614,960 and 6,442,321 supra. Such structures are termed “phase-based” hydrogen sensors.

### Example 17

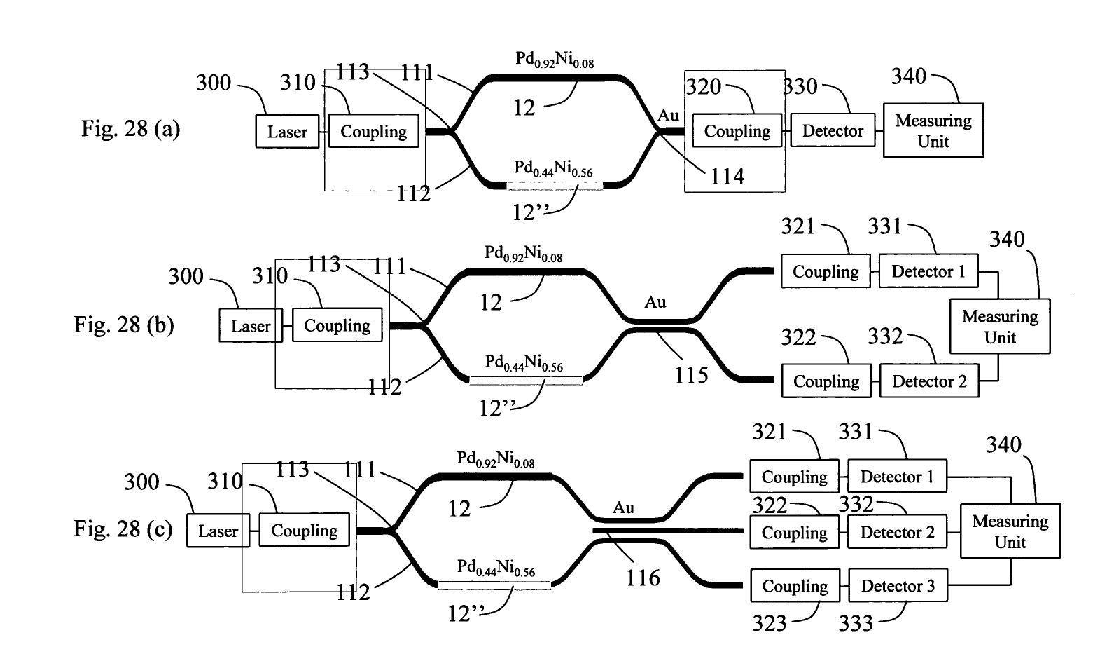

FIG. 28(a) shows schematically a Mach-Zehnder interferometer sensor comprising a laser source 300 and input means 310 similar to those shown in FIG. 27(a) connected to the input of a Y-junction splitter 113. The input Y-junction splitter 113 leads to two branches 111 and 112. Branch 111 is connected to the input end of the Pd_{0.92}Ni_{0.08} strip 12 (or adlayer 100) which is the H₂ sensing medium. Branch 112 is connected to the input end of the Pd_{0.44}Ni_{0.56} strip 12″ which is insensitive to H₂. The outputs of strips 12 and 12″ are then combined into one output strip using a Y-junction combiner 114. The output is connected via output coupling means 320 to detector 330, as in the example of FIG. 27(a).

One of the branches, specifically the sensing branch, comprises a Pd_{0.92}Ni_{0.08} strip 12 (or adlayer 100) as the H₂ sensing medium, while the other branch, the reference branch, comprises a Pd_{0.44}Ni_{0.56} strip 12″ insensitive to H₂. The same environment E is then allowed into contact with both branches. Hence, the sensing branch undergoes a change in insertion phase as H₂ absorbs into the Pd_{0.92}Ni_{0.08}, while the reference branch maintains a constant insertion phase. The difference between the insertion phase of the sensing branch and the insertion phase of the reference branch is termed the phase difference; clearly, the phase difference changes as H₂ absorbs into the sensing branch.

The Y-junction combiner 114 combines the optical fields emerging from the sensing and reference branches into one output thus converting changes in phase difference to changes in intensity as captured by the detector 330. Hence, the measuring unit 340 monitors the output optical power over time and compares it against its initial value (e.g.: prior to exposure to H₂). A prescribed change in this power is taken as an indication that H₂ is present in the environment.

Advantageously, if the reference branch is of the same length as the sensing branch and both are of identical design, then the reference branch used in this manner compensates substantially for thermal and strain variations along the device, and for changes in the bulk index of the environment E caused by thermal or compositional changes, since these effects occur substantially identically along both the sensing branch and reference branch due to their physical proximity; i.e.: these perturbations change the insertion phase of both branches substantially identically. The reference branch also compensates substantially for non-specific interactions with the environment, which occur substantially identically along both branches.

In order to obtain a unity visibility factor for the interferometer (i.e.: the greatest fringe contrast), the Y-junction splitter 113 and combiner 114 should be designed for an equal power split and the attenuation and length of the sensing branch should be identical to those of the reference branch. This is readily achieved since the optical absorption (k) of Pd_{0.92}Ni_{0.08} is substantially the same as that of Pd_{0.44}Ni_{0.56}. A reference optical output signal could be added by incorporating either a scattering means 63 (see FIG. 37) in front of the input Y-junction splitter 113, or by introducing a coupler at the same location. A reference signal is advantageous in that source fluctuations can be substantially eliminated from the measured signal by the ratio of the measured to the reference power.

### Example 18

FIG. 28 (b) shows a schematic of a Mach-Zehnder interferometer sensor similar to that of FIG. 28 (a), comprising a laser source 300 and input means 310 similar to those shown in FIG. 27(a) connected to the input of a Y-junction splitter 113. The input Y-junction splitter 113 leads to two branches 111 and 112. Branch 111 is connected to the input end of the Pd_{0.92}Ni_{0.08} strip 12 (or adlayer 100) which is the H₂ sensing medium. Branch 112 is connected to the input end of the Pd_{0.44}Ni_{0.56} strip 12″ which is insensitive to H₂ The outputs of strips 12 and 12″ are then combined into two outputs using a dual output coupler 115. The outputs of the dual output coupler 115 are connected via output coupling means 321 and 322 to detectors 331 and 332, respectively.

A particularly good design choice for the coupler 115 is a 3 dB coupler, since in this case, the two output powers are complementary and their sum remains constant as a function of the phase difference. This confers additional advantages over the single output version shown in FIG. 28 (a) in that source and input coupling fluctuations can be rejected from the measurement by referencing (i.e.: forming the ratio of) one of the output powers to the sum of both or by referencing their difference to their sum. Hence, the measuring unit 340 monitors such a ratio over time and compares it against its initial value (e.g.: prior to exposure to H₂). A change in the ratio is taken as an indication that H₂ is present in the environment.

### Example 19

FIG. 28 (c) shows a schematic of a Mach-Zehnder interferometer similar to that of FIG. 28 (b), comprising a laser source 300 and input means 310 similar to those shown in FIG. 27(a) connected to the input of a Y-junction splitter 113. The input Y-junction splitter 113 leads to two branches 111 and 112. Branch 111 is connected to the input end of the Pd_{0.92}Ni_{0.08} strip 12 (or adlayer 100) which is the H₂ sensing medium. Branch 112 is connected to the input end of the Pd_{0.44}Ni_{0.56} strip 12″ which is insensitive to H₂. The outputs of strips 12 and 12″ are then combined into three outputs using a triple output coupler 116. The outputs of the triple output coupler 116 are connected via output coupling means 321, 322 and 323 to detectors 331, 332 and 333, respectively.

A particularly good design choice for the coupler 116 is one where the responses of the three output powers versus the phase difference are shifted by 120° with respect to each other. In this case, the sum of the three output powers remains constant as a function of the phase difference. Hence all three output powers are monitored independently, each referenced to the sum of all three, thus conferring additional advantages over the dual output version shown in FIG. 28(b) in that sensitivity fading and directional ambiguity of the Mach-Zehnder interferometer response are substantially mitigated. Hence, the measuring unit 340 monitors these powers over time and compares them against their initial values (e.g.: prior to exposure to H₂). A change in the powers is taken as an indication that H₂ is present in the environment.

For sensing and reference branches of equal length L and identical design (and hence of identical effective refractive index), the phase difference Δφ due to H₂ absorption is given by Δφ=2πLΔn_{eff}/λ₀ where Δn_{eff}=Δh(c)∂n_{eff}/∂h(c) is the change in the effective index of the sensing branch due H₂ absorption. The maximum length selected for the sensing and reference branches and will be determined either by the maximum tolerable insertion loss of the branches or by another constraint such as, for example, the diameter of the substrate wafer upon which the devices are fabricated.

### Example 20

Based on Example 12 and FIGS. 25 and 26, membrane and strip thicknesses of d=15 nm and t=80 nm are selected, respectively, leading to values of ∂MPA/∂h(c)˜0, MPA=1.31 dB/10 μm, ∂neff/∂h(c)=−7.22×10⁻³, and hence (∂neff/∂h(c))/MPA=−5.51×10⁻³ 10 μm/dB which is a near optimal ratio. Choosing an insertion loss of 25 dB for the sensing and reference branches, assuming a minimum detectable phase difference of φΔₘᵢₙ=230 to 23 grad, and using Δφ=2πLΔh(c)·∂n_{eff}/∂h (c)/λ₀, leads to a detection limit of Δh(c)ₘᵢₙ=4×10⁻⁵ to 4×10⁻⁶ and hence a detection limit in H₂ concentration of Δₘᵢₙ˜4 to 0.4 ppm.

The modeling framework described in the article “Passive integrated optics elements based on long-range surface plasmon polaritons” by R. Charbonneau, C. Scales, L Breukelaar, S. Fafard, N. Lahoud, G. Mattiussi and P. Berini, Journal of Lightwave Technology, Vol. 24, pp. 477-494, 2006 can be combined with the coupled mode theories described in the articles “Integrated optical Mach-Zehnder Biosensor” by B. J. Luff, J S. Wilkinson, J Piehler, U. Hollenbach, J. Ingenhoff and N. Fabricius, Journal of Lightwave Technology, Vol. 16, pp. 583-592, 1998 and “Application of the strongly coupled-mode theory to integrated optical devices” by S.-L. Chuang, IEEE Journal of Quantum Electronics, Vol. QE-23, pp. 499-509, 1987, in order to model the full end-to-end structure, including the dual and triple output couplers.

### Example 21

FIGS. 31(a) to 31(e) show an implementation of the Mach-Zehnder interferometer sensor described under Example 17 and shown schematically in FIG. 41(a). In this implementation a bottom chip 120, shown schematically in cross-sectional view in FIGS. 31(a) and 31(b) and in top view in FIG. 31(c), is combined with a top chip 121 shown in cross-sectional view in FIG. 31(d) and in top view in FIG. 31(e), in order to enclose each of the sensing and reference branches of the interferometer within the environment E, thus enabling access to the branches via the top chip inlets/outlets 200. The channels confining the environment are formed within the transparent material 90, as shown in FIG. 31(a). This material is also used as an optical cladding in the regions away from the environment, as shown in FIG. 31(b). Butt-coupling with optical fibres at the input and output of the chip is used. Suitable choices for the material 90 and the top chip 121 shown in FIGS. 31(d)-(e) are the same as those identified for the membrane with a particularly good choice being SiO₂ when the membrane is Si₃N₄.

FIG. 32(a) shows a cross-sectional view taken along cut A of the assembly resulting from the combination of the bottom chip shown in FIGS. 31(a)-(c) and the top chip shown in FIGS. 31(d)-(e). Clamping the assembly with force or bonding the chips 120 and 121 using an adhesive ensures that the top and bottom chips 121 and 120 are sealed along the top surface of the bottom chip 120 thus ensuring that the environment E is contained within the channels 125.

FIG. 32(b) shows a partial longitudinal cross-sectional view of the assembly taken along one of the branches.

Any other Mach-Zehnder architecture, including those shown in FIG. 28 (b) and (c), could be implemented in this manner.

### Example 22

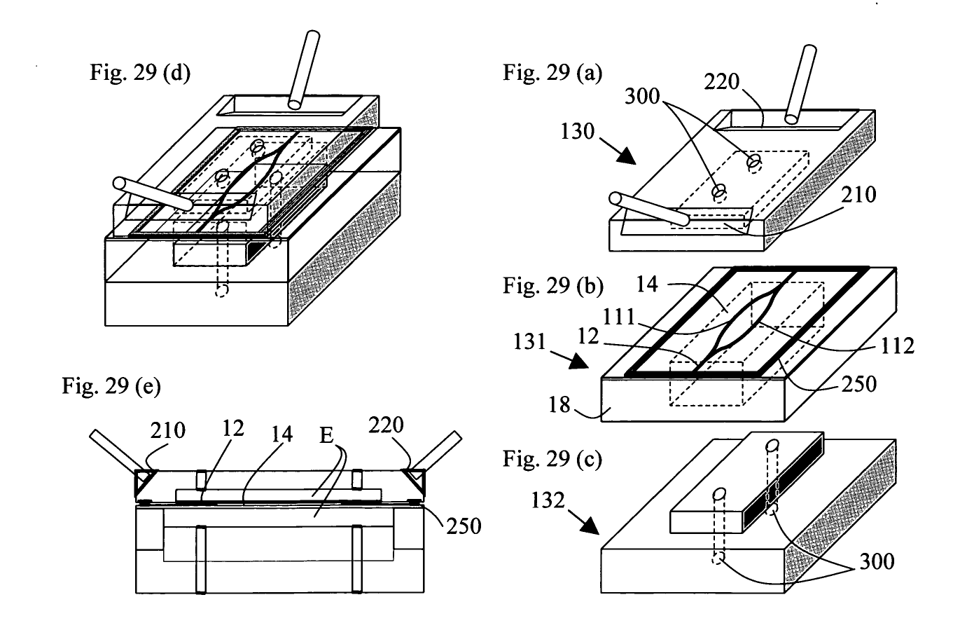

FIGS. 29(a) to 29(e) show another implementation of the Mach-Zehnder interferometer sensor. In this implementation a bottom chip 132, shown schematically in FIG. 29(c), and a top chip 130, shown schematically in FIG. 29(a), are combined with a middle chip 131 shown schematically in FIG. 29(b) in order to enclose an entire interferometer within the environment E, thus enabling access to the sensing and reference branches via the top and bottom chip inlets/outlets 300. The assembly is shown schematically in FIG. 29(d) and in longitudinal central cross-sectional view in FIG. 29(e). As depicted in FIG. 29(a) and FIG. 29(e), the top chip has beveled edges 210 and 220 and is accurately spaced a distance s from the strip 12 by a spacer ring 250, effectively enabling evanescent prism coupling of the input/output light beams, as in FIG. 34 and FIGS. 33(c) and (d). FIG. 29(b) shows the spacer ring 250 as completely surrounding the membrane and thus serving the dual purpose of providing the required spacing s for efficient coupling and of providing a seal between the top chip and the middle chip. The membrane 14 depicted in FIG. 29(b) is implemented as in FIG. 31, and the spacer ring 250 is located over the substrate 18, away from the membrane 14, hence allowing the top, middle and bottom chips 130, 131 and 132, respectively, to be clamped with force in the assembly shown in FIG. 29(d). Clamping with force or bonding using an adhesive ensures that the top and middle chips are sealed along the ring 250 and that the bottom and middle chips are sealed along the top surface of the bottom chip, as shown in FIGS. 29(d) and (e), thus ensuring that the environment E is contained.

Suitable choices for the material of the top chip 130 shown in FIG. 29(a) are the same as those identified for the membrane 14 with a particularly good choice being SiO₂. Many materials could be used for the bottom chip 132 with a particularly good choice being a thermally conductive material thus enabling control over the temperature of the environment E by controlling the temperature of the bottom chip 132. Many materials could be used for the spacer ring 250, suitable choices being materials which are conveniently deposited and patterned during fabrication of the middle chip 131. The metals identified for the strip 12 are particularly good choices for the spacer ring 250.

FIGS. 30(a) to 30(e) depict an arrangement similar to that shown in FIGS. 29(a) to 29(e) except that the output prism-like coupler partially defined by the beveled edge 220 is replaced with a scattering centre 63, similar to that shown in FIG. 37, and a detector or detector array 150 is positioned on the top surface of the top chip 140. Any other Mach-Zehnder architecture, including those shown in FIGS. 28(b) and (c), could be implemented in this manner.

It should be noted that the sensor implementations depicted in FIGS. 29-32 could be straightforwardly adapted for use with any of the Mach-Zehnder interferometer structures sketched in FIG. 28, or any of the attenuation-based structures sketched in FIG. 27, or any obvious variant thereof.

Because a membrane waveguide embodying the present invention comprises a strip 12 of relatively high free charge carrier density, in addition to guiding the ss_{b}⁰ mode, the strip 12 could act as an electrical conductor or as an electrode. To achieve this, non-optically invasive electrical contacts to the strip 12 can be implemented, for example, as thin, narrow arms protruding substantially perpendicularly from the strip 12 and ending in large area contact pads in a region away from the membrane and overlying the substrate 18, as described in international patent application number PCT/CA2006/001080 published as WO/2007/000057.

Making electrical contact with a Mach-Zehnder interferometer provides advantages and added functionality. For instance, a current source can be connected to a pair of contacts on the same branch in order to pass a current through the strip 12 of the branch thus heating the strip (due to ohmic loss) and the surrounding environment near the strip. Heating the hydrogen-sensing medium (Pd_{0.92}Ni_{0.08} strip 12 or adlayer 100) desorbs H₂O (and other contaminants) from the surface and reduces aging and interference effects. Using an alternating current in one branch provides the benefits described above but additionally adds a phase modulation of known frequency onto the ss_{b}⁰ mode propagating along the branch, which is useful for further improving the signal to noise ratio of the detected output optical signals. Modulation of the ss_{b}⁰ mode is achieved via the thermo-optic effect, present in the strip material 12 (metals, including Pd and Pd alloys, have a high thermo-optic coefficient dN/dT).

The alternating current can have one of various waveforms including sinusoidal, triangular, rectangular and pulsed. Current can be passed in the manner described above through the sensing branch only, the reference branch only or both as dictated by the application.

Connecting electrically to the attenuation-based sensors shown in FIG. 27 leads to similar advantages.

Hydrogen sensors can be implemented using periodic structures and Bragg gratings according to the teachings of U.S. Pat. No. 6,823,111, but using waveguide structures embodying the present invention along with an H₂ sensing medium (Pd_{0.92}Ni_{0.08}) as the strip 12 or adlayer 100.

It should be noted that the H₂ sensing medium in the embodiments described hereinbefore can be Pd, or an alloy of Pd with another metal(s) such as Ni over a suitable range of composition, without departing from the scope of the present invention.

It should be noted that, although plasmon-polariton waveguides using finite width thin strips surrounded by dielectric material have been disclosed by the present inventor et al. in, for example, U.S. Pat. Nos. 6,442,321, 6,614,960, 6,801,691, 6,283,111, 6,741,782, 6,914,999, 7,026,701 and 7,043,104, the teachings of those patents would lead a skilled addressee to conclude that a membrane could not be interposed between the strip 12 and its surroundings or environment E without causing significant deleterious performance. The present invention is predicated upon the unexpected discovery that, providing certain conditions are met, a practically realizable membrane can be interposed without severely deleteriously affecting propagation of the plasmon-polariton wave, for example the long-range ss_{b}⁰ mode.

An advantage of embodiments of the present invention is that the membrane 14 can be arranged to support the strip 12 in an environment that is gaseous or vacuum. It should be appreciated that suitable packaging will be provided in a manner that allows the environment to permeate the sensor region. The design and implementation of such packaging is well within the knowledge of the skilled addressee and so will not be described in detail herein.

An advantage of the use of a membrane by embodiments of the present invention is that it is relatively simple to ensure that the optical properties of the environment E around the strip are substantially the same.

Advantages of embodiments of the present invention include the fact that they are inherently safe, since electronics and optoelectronics can be removed from the sensor head eliminating the potential for ignition via electrical sparks. Long optical interaction lengths of the chemical transducers lead to high sensitivity. Because they are immune to electromagnetic interference, they can be used in an electromagnetically noisy environment. In addition, they have a large dynamic range with linear response over decades of concentrations.

Although an embodiment of the invention has been described and illustrated in detail, it is to be clearly understood that the same is by way of illustration and example only and not to be taken by way of limitation, the scope of the present invention being limited only by the appended claims.

The reader is directed for reference to the documents identified hereinbefore, and to the following documents, the entire contents of each and every one of these documents being incorporated herein by reference:
[1] C. Christofides et al., J. Appl. Phys., 63, p. R1, 1990
[2] X. Bévenot et al., Meas. Sci. Technol., 13, p. 118, 2002
[3] M. A. Butler, J. Electrochem. Soc., 138, p. L46, 1991
[4] M. A. Butler, Appl. Phys. Lett., 45, p. 1007, 1984
[5] M. A. Butler, D. S. Ginley, J. Appl. Phys., 64, p. 3706, 1988
[6] J. E. Schirber et al., Phys. Rev. B, 12, p. 117, 1975
[7] J. C. Barton et al., Trans. Faraday Soc., 62, p. 960, 1966
[8] D. A. Papaconstantopoulos et al., Phys. Rev. B, 17, p. 141, 1978
[9] R. Riedinger et al., Phil. Mag. B, 44, p. 547, 1981
[10] R. Riedinger et al., J. de Phys., 43, p. 323, 1982
[11]) K. Wyrzykowski et al., J. Phys.: Condens. Matter, 1, p. 2269, 1989
[12] X. Bévenot et al., Sens. Act. B, 67, p. 57, 2000
[13] K. von Rottkay et al., J. Appl. Phys., 85, p. 408, 1999
[14] G. K. Mor et al., J. Appl. Phys., 90, p. 1795, 2001
[15] Z. Opilski et al., SPIE, 5576, p. 208, 2004
[16] Hughes et al., J. Appl. Phys., 71, p. 542, 1992
[17] R. C. Hughes et al., J. Electrochem. Soc., 142, p. 249, 1995
[18] B. Chadwick et al., Sens. Act. B, 15, p. 215, 1994
[19] K. Sharnagl et al., Sens. Act. B, 78, p. 138, 2001.

1. A gas sensor having a plasmon-polariton waveguide comprising a metal strip on a membrane supported by a substrate in an environment in which the gas to be sensed may be present, input means for coupling optical radiation into the plasmon-polariton waveguide such that the optical radiation propagates therealong as a plasmon-polariton wave and output means for receiving said optical radiation following said propagation, the metal strip comprising a chemical transducer, the arrangement being such that exposure of the chemical transducer to the gas to be sensed causes a change in the propagation characteristics of the plasmon-polariton wave propagating along the waveguide and hence a change in the optical radiation coupled out of the plasmon-polariton waveguide, the output means comprising means for monitoring for a change in said propagated optical radiation consistent with the presence of a prescribed level of the gas in the environment contacting the transducer.

2. A gas sensor according to claim 1, wherein the chemical transducer comprises palladium or a palladium-based alloy, such as palladium-nickel.

3. A gas sensor according to claim 1, wherein the strip has a surface layer of said chemical transducer, e.g., as an adlayer.

4. A gas sensor according to claim 1, for use in sensing an analyte of, for example, a chemical nature, wherein the chemical transducer material i.e., adlayer, comprises receptors for binding with the analyte.

5. A sensor according to claim 1, wherein the membrane means extends between spaced supports.

6. A gas sensor according to claim 1, wherein the membrane covers a surface of the strip and is substantially non-invasive optically.

7. A sensor according to claim 1, wherein the membrane means is permeable, apertured, porous or otherwise configured so as to allow the gas to contact the chemical transducer through the membrane means.

8. A gas sensor according to claim 7, wherein the membrane (14) has a plurality of apertures (26) spaced apart along its length, said juxtaposed portion of the strip comprising parts (28) of the strip exposed through respective ones of said apertures, and margin portions (30) of the strip (12) around the exposed parts (28) overlie and are attached to respective parts (32) of the membrane (14).

9. A gas sensor according to claim 8, wherein the exposed parts (28) of the strip each extend into the respective one of the apertures (26).

10. A gas sensor according to claim 1, wherein the material of the membrane structure (14) comprises an optical dielectric selected, for example, from a group including glass, quartz, polymer, SiO2, Si3N4, silicon oxynitride (SiON), LiNbO3, PLZT, and undoped or very lightly doped semiconductors such as GaAs, InP, Si and Ge.

11. A gas sensor according to claim 10, wherein the material of the membrane structure (14) comprises SiO2, SiON or Si3N4.

12. A gas sensor according to claim 10, wherein the material of the membrane structure (14) is a polymer selected from the group comprising BCB, polyimide, PMMA, Teflon AF (TM), SU8.

13. A gas sensor according to claim 1, further comprising means (16) for confining adjacent at least one side of said strip (12) at least a part of said environment (E) that comprises either a vacuum or a gas and means for admitting the gas to be sensed into the confined environment and the membrane means (14) supports said strip (12) such that the chemical transducer extends at least partially within the confined environment.

14. A gas sensor according to claim 13, wherein the confining means comprises a channel (16) and the membrane means (14) divides the channel longitudinally into two cavities (16′, 16″), the strip (12) extending longitudinally and medially along the membrane means.

15. A gas sensor according to claim 1, wherein the input means comprises means (20) for coupling input optical radiation in an endfire manner to one end of said strip (12) so as to propagate along said strip as said plasmon-polariton wave.

16. A gas sensor according to claim 15, wherein the input coupling means comprises a polarization maintaining fiber (PMF) for inputting said optical radiation from a source thereof into said plasmon-polariton waveguide.

17. A gas sensor according to claim 1, wherein the input means comprises means (20,60) for coupling input optical radiation laterally to said strip (12) to propagate along said strip as said plasmon-polariton wave.

18. A gas sensor according to claim 1, wherein the output means comprises a single mode fiber for conveying optical radiation out of the plasmon-polariton waveguide to said monitoring means.

19. A gas sensor according to claim 1, wherein the output means comprises means for conveying optical radiation from the plasmon-polariton waveguide to monitoring means located nearby, for example within the same compact module, or at a remote location, such as in another building.

20. A gas sensor according to claim 1, wherein the output means comprises means (22) for extracting at least part of said plasmon-polariton wave in an endfire manner at an opposite end of said strip (12).

21. A gas sensor according to claim 15, wherein the output means comprises means (22,62) for extracting at least part of said plasmon-polariton wave laterally from said strip.

22. A gas sensor according to claim 15, wherein said monitoring means comprises first and second detectors whose respective electrical outputs are connected to a measuring unit, and wherein the input coupling means comprises a coupler having one output connected to an input end of the first plasmon-polariton waveguide and a second output connected to an input end of a second plasmon-polariton waveguide that is insensitive to said gas to be sensed, respective other ends of the first and second plasmon-polariton waveguides being connected to first and second detection means, respectively.

23. A gas sensor according to claim 15, wherein said monitoring means comprises first and second detectors whose respective electrical outputs are connected to a measuring unit, and wherein the input coupling means comprises a Y-junction having its leg connected to receive the optical radiation, one output connected to an input end of the first plasmon-polariton waveguide and a second output connected to an input end of a second plasmon-polariton waveguide that is insensitive to said gas to be sensed, respective other ends of the first and second plasmon-polariton waveguides being connected to first and second detection means, respectively.

24. A gas sensor according to claim 18, wherein the first plasmon-polariton waveguide has a strip comprising PD_{0.92} Ni₀₈ and the second plasmon-polariton waveguide has a strip comprising Pd_{0.44} Ni_{0.56}.

25. A gas sensor according to claim 15, wherein the input means comprises coupling means for coupling said optical radiation into the leg of a Y-junction having its branch arms connected to, respectively, input ends of the first-mentioned plasmon-polariton waveguide and a second, similar plasmon-polariton waveguide, but having no chemical transducer, respective opposite ends of the first and second plasmon-polariton waveguides being connected to respective branch arms of a second Y-junction whose leg is connected to a detector having its electrical output applied to said measuring means.

26. A gas sensor according to claim 15, wherein the input means comprises coupling means for coupling said optical radiation into the leg of a Y-junction having its branch arms connected to, respectively, input ends of the first-mentioned plasmon-polariton waveguide and a second, similar plasmon-polariton waveguide, but having no chemical transducer, respective opposite ends of the first and second plasmon-polariton waveguides being connected to respective inputs of a four-port coupler (115) whose corresponding outputs are coupled to first and second detector having their respective electrical signals applied to said measuring means.

27. A gas sensor according to claim 15, wherein the input means comprises coupling means for coupling said optical radiation into the leg of a Y-junction having its branch arms connected to, respectively, input ends of the first-mentioned plasmon-polariton waveguide and a second, similar plasmon-polariton waveguide that is insensitive to said gas to be sensed, respective opposite ends of the first and second plasmon-polariton waveguides being connected to respective inputs of a triple-out coupler (116) whose three outputs are connected to, respectively, first, second and third detectors having their respective electrical outputs coupled to said measuring means.

28. A gas sensor according to claim 25, wherein the first plasmon-polariton waveguide has a strip comprising PD_{0.92} Ni₀₈ and the second plasmon-polariton waveguide has a strip comprising Pd_{0.44}Ni_{0.56}.

29. A gas sensor according to claim 1, and having materials and dimensions as set out in any one of Examples 1 to 22 described in this specification.
